(19) United States
(12) Patent Application Publication
(10) Pub. No.: US 2026/0173008 A1
(43) Pub. Date: Jun. 18, 2026

(54) TECHNIQUES FOR VIRTUAL CELL SELECTION FOR MULTI-CARRIER OPERATION

(71) Applicant: QUALCOMM Incorporated, San Diego, CA (US)

(72) Inventors: Aria HASANZADEZONUZY, Chatham, NJ (US); Kianoush HOSSEINI, San Diego, CA (US); Umesh PHUYAL, San Diego, CA (US); Ozcan OZTURK, San Diego, CA (US)

(21) Appl. No.: 18/981,273

(22) Filed: Dec. 13, 2024

(51) Int. Cl. H04W 60/04; H04L 5/00; H04W 24/10; H04W 48/02

(52) U.S. Cl. CPC H04W 60/04; H04L 5/0051; H04W 24/10; H04W 48/02

(57) ABSTRACT

Methods, systems, and devices for wireless communications are described. Specifically, techniques for selecting virtual cells (vCells) including multiple serving cells are described. A user equipment (UE) may receive control signaling that indicates a set of resources for receiving reference signals from a vCell, where the vCell includes a set of serving cells that are grouped together to facilitate wireless communications. The UE may then perform measurements on reference signals received from the vCell, via the set of resources, and may perform a cell attachment procedure with the vCell to access the set of serving cells based on a set of metrics associated with the set of serving cells satisfying one or more criteria for accessing the vCell. In some cases, the UE may attach to the vCell if the criteria for all (or a subset) of the serving cells of the vCell are satisfied.

### FIELD OF TECHNOLOGY

The following relates to wireless communications, including techniques for virtual cell (vCell) selection for multi-carrier operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include receiving control signaling that indicates a set of resources for receiving reference signals from a virtual cell (vCell), where the vCell includes a set of serving cells that are grouped together to facilitate wireless communications, receiving one or more reference signals from the set of serving cells of the vCell via the set of resources, performing measurements on the one or more reference signals, and performing a cell attachment procedure with the vCell to access the set of serving cells based on a set of metrics associated with the set of serving cells satisfying one or more criteria for accessing the vCell, where the set of metrics are based on the measurements.

A UE is described. The UE may include one or more memories storing processor executable code, and one or more processors coupled with the one or more memories. The one or more processors may individually or collectively be operable to execute the code to cause the UE to receive control signaling that indicates a set of resources for receiving reference signals from a vCell, where the vCell includes a set of serving cells that are grouped together to facilitate wireless communications, receive one or more reference signals from the set of serving cells of the vCell via the set of resources, perform measurements on the one or more reference signals, and perform a cell attachment procedure with the vCell to access the set of serving cells based on a set of metrics associated with the set of serving cells satisfying one or more criteria for accessing the vCell, where the set of metrics are based on the measurements.

Another UE is described. The UE may include means for receiving control signaling that indicates a set of resources for receiving reference signals from a vCell, where the vCell includes a set of serving cells that are grouped together to facilitate wireless communications, means for receiving one or more reference signals from the set of serving cells of the vCell via the set of resources, means for performing measurements on the one or more reference signals, and means for performing a cell attachment procedure with the vCell to access the set of serving cells based on a set of metrics associated with the set of serving cells satisfying one or more criteria for accessing the vCell, where the set of metrics are based on the measurements.

A non-transitory computer-readable medium storing code is described. The code may include instructions executable by one or more processors to receive control signaling that indicates a set of resources for receiving reference signals from a vCell, where the vCell includes a set of serving cells that are grouped together to facilitate wireless communications, receive one or more reference signals from the set of serving cells of the vCell via the set of resources, perform measurements on the one or more reference signals, and perform a cell attachment procedure with the vCell to access the set of serving cells based on a set of metrics associated with the set of serving cells satisfying one or more criteria for accessing the vCell, where the set of metrics are based on the measurements.

In some examples of the method, UEs, and non-transitory computer-readable medium described herein, the set of serving cells of the vCell include at least a first serving cell and a second serving cell, the set of metrics include at least a first metric and a second metric associated with the first serving cell and the second serving cell, respectively, and the set of metrics satisfy the one or more criteria based on the first metric satisfying a first criteria associated with the first serving cell, and the second metric satisfying a second criteria associated with the second serving cell.

Some examples of the method, UEs, and non-transitory computer-readable medium described herein may further include operations, features, means, or instructions for transmitting one or more signals to the vCell and receiving a message from the vCell indicating one or more characteristics associated with the one or more signals received via the set of serving cells of the vCell, and where the set of metrics may be based on the one or more characteristics.

Some examples of the method, UEs, and non-transitory computer-readable medium described herein may further include operations, features, means, or instructions for receiving an indication of the one or more criteria for accessing the vCell, where performing the measurements, performing the cell attachment procedure, or both, may be based on receiving the indication of the one or more criteria.

In some examples of the method, UEs, and non-transitory computer-readable medium described herein, receiving the indication of the one or more criteria may include operations, features, means, or instructions for receiving an indication of a first criteria associated with the first serving cell based on the first serving cell being associated with a first frequency range and receiving an indication of a second criteria associated with the second serving cell based on the second serving cell being associated with a second frequency range.

Some examples of the method, UEs, and non-transitory computer-readable medium described herein may further include operations, features, means, or instructions for receiving a system information block including the indication of the one or more criteria for accessing the vCell.

In some examples of the method, UEs, and non-transitory computer-readable medium described herein, the set of serving cells of the vCell include a set of multiple serving cells, the set of metrics include a set of multiple metrics corresponding to the set of multiple serving cells, and the set of metrics satisfy the one or more criteria based on each of the set of multiple metrics satisfying the one or more criteria.

In some examples of the method, UEs, and non-transitory computer-readable medium described herein, the set of serving cells of the vCell include a set of multiple serving cells, the set of metrics include a set of multiple metrics corresponding to the set of multiple serving cells, and the set of metrics satisfy the one or more criteria based on a threshold quantity of the set of multiple metrics satisfying the one or more criteria.

Some examples of the method, UEs, and non-transitory computer-readable medium described herein may further include operations, features, means, or instructions for receiving an indication of the threshold quantity, where performing the cell attachment procedure may be based on receiving the indication of the threshold quantity.

Some examples of the method, UEs, and non-transitory computer-readable medium described herein may further include operations, features, means, or instructions for receiving an indication of one or more serving cells of the set of serving cells that may be required to satisfy the one or more criteria for attaching to the vCell, where the set of metrics include one or more metrics associated with the one or more serving cells, where the set of metrics satisfy the one or more criteria based on one or more metrics satisfying the one or more criteria.

In some examples of the method, UEs, and non-transitory computer-readable medium described herein, the UE may be barred from attaching to the vCell based on the set of metrics failing to satisfy the one or more criteria.

In some examples of the method, UEs, and non-transitory computer-readable medium described herein, the UE may be further barred from attaching to any of the set of serving cells of the vCell based on the set of metrics failing to satisfy the one or more criteria.

In some examples of the method, UEs, and non-transitory computer-readable medium described herein, the set of serving cells of the vCell may be individually accessible by the UE despite the UE being barred from attaching to the vCell.

Some examples of the method, UEs, and non-transitory computer-readable medium described herein may further include operations, features, means, or instructions for receiving, from the vCell, additional control signaling indicating that the UE may be barred from accessing the vCell based on the set of metrics failing to satisfy the one or more criteria.

Some examples of the method, UEs, and non-transitory computer-readable medium described herein may further include operations, features, means, or instructions for communicating with the first subset of serving cells of the vCell based on performing the cell attachment procedure and based on the first subset of metrics satisfying the one or more criteria and refraining from communicating with the second subset of serving cells of the vCell based on the second subset of metrics failing to satisfy the one or more criteria.

In some examples of the method, UEs, and non-transitory computer-readable medium described herein, the vCell may be configured to perform communications associated with a service and the set of serving cells of the vCell may be associated with the service, a different service, or both.

A method by a network entity is described. The method may include outputting control signaling that indicates a set of resources for transmitting reference signals via a vCell supported by the network entity, where the vCell includes a set of serving cells that are grouped together to facilitate wireless communications, outputting one or more reference signals via the set of serving cells of the vCell via the set of resources, and performing a cell attachment procedure for a UE to enable the UE to access the set of serving cells of the vCell based on a set of metrics associated with the set of serving cells satisfying one or more criteria for accessing the vCell, where the set of metrics are based on the reference signals.

A network entity is described. The network entity may include one or more memories storing processor executable code, and one or more processors coupled with the one or more memories. The one or more processors may individually or collectively be operable to execute the code to cause the network entity to output control signaling that indicates a set of resources for transmitting reference signals via a vCell supported by the network entity, where the vCell includes a set of serving cells that are grouped together to facilitate wireless communications, output one or more reference signals via the set of serving cells of the vCell via the set of resources, and perform a cell attachment procedure for a UE to enable the UE to access the set of serving cells of the vCell based on a set of metrics associated with the set of serving cells satisfying one or more criteria for accessing the vCell, where the set of metrics are based on the reference signals.

Another network entity is described. The network entity may include means for outputting control signaling that indicates a set of resources for transmitting reference signals via a vCell supported by the network entity, where the vCell includes a set of serving cells that are grouped together to facilitate wireless communications, means for outputting one or more reference signals via the set of serving cells of the vCell via the set of resources, and means for performing a cell attachment procedure for a UE to enable the UE to access the set of serving cells of the vCell based on a set of metrics associated with the set of serving cells satisfying one or more criteria for accessing the vCell, where the set of metrics are based on the reference signals.

A non-transitory computer-readable medium storing code is described. The code may include instructions executable by one or more processors to output control signaling that indicates a set of resources for transmitting reference signals via a vCell supported by the network entity, where the vCell includes a set of serving cells that are grouped together to facilitate wireless communications, output one or more reference signals via the set of serving cells of the vCell via the set of resources, and perform a cell attachment procedure for a UE to enable the UE to access the set of serving cells of the vCell based on a set of metrics associated with the set of serving cells satisfying one or more criteria for accessing the vCell, where the set of metrics are based on the reference signals.

In some examples of the method, network entities, and non-transitory computer-readable medium described herein, the set of serving cells of the vCell include at least a first serving cell and a second serving cell, the set of metrics include at least a first metric and a second metric associated with the first serving cell and the second serving cell, respectively, and the set of metrics satisfy the one or more criteria based on the first metric satisfying a first criteria associated with the first serving cell, and the second metric satisfying a second criteria associated with the second serving cell.

Some examples of the method, network entities, and non-transitory computer-readable medium described herein may further include operations, features, means, or instructions for obtaining one or more signals from the UE and outputting a message to the UE via the vCell, the message indicating one or more characteristics associated with the one or more signals received via the set of serving cells of the vCell, and where the set of metrics may be based on the one or more characteristics.

Some examples of the method, network entities, and non-transitory computer-readable medium described herein may further include operations, features, means, or instructions for outputting an indication of the one or more criteria for accessing the vCell, where performing the cell attachment procedure may be based on outputting the indication of the one or more criteria.

In some examples of the method, network entities, and non-transitory computer-readable medium described herein, outputting the indication of the one or more criteria may include operations, features, means, or instructions for outputting an indication of a first criteria associated with the first serving cell based on the first serving cell being associated with a first frequency range and outputting an indication of a second criteria associated with the second serving cell based on the second serving cell being associated with a second frequency range.

Some examples of the method, network entities, and non-transitory computer-readable medium described herein may further include operations, features, means, or instructions for outputting a system information block including the indication of the one or more criteria for accessing the vCell.

In some examples of the method, network entities, and non-transitory computer-readable medium described herein, the set of serving cells of the vCell include a set of multiple serving cells, the set of metrics include a set of multiple metrics corresponding to the set of multiple serving cells, and the set of metrics satisfy the one or more criteria based on each of the set of multiple metrics satisfying the one or more criteria.

In some examples of the method, network entities, and non-transitory computer-readable medium described herein, the set of serving cells of the vCell include a set of multiple serving cells, the set of metrics include a set of multiple metrics corresponding to the set of multiple serving cells, and the set of metrics satisfy the one or more criteria based on a threshold quantity of the set of multiple metrics satisfying the one or more criteria.

Some examples of the method, network entities, and non-transitory computer-readable medium described herein may further include operations, features, means, or instructions for outputting an indication of the threshold quantity, where performing the cell attachment procedure may be based on outputting the indication of the threshold quantity.

Some examples of the method, network entities, and non-transitory computer-readable medium described herein may further include operations, features, means, or instructions for outputting an indication of one or more serving cells of the set of serving cells that may be required to satisfy the one or more criteria for attaching to the vCell, where the set of metrics include one or more metrics associated with the one or more serving cells, where the set of metrics satisfy the one or more criteria based on one or more metrics satisfying the one or more criteria.

In some examples of the method, network entities, and non-transitory computer-readable medium described herein, the UE may be barred from attaching to the vCell based on the set of metrics failing to satisfy the one or more criteria.

In some examples of the method, network entities, and non-transitory computer-readable medium described herein, the UE may be further barred from attaching to any of the set of serving cells of the vCell based on the set of metrics failing to satisfy the one or more criteria.

In some examples of the method, network entities, and non-transitory computer-readable medium described herein, the set of serving cells of the vCell may be individually accessible by the UE despite the UE being barred from attaching to the vCell.

Some examples of the method, network entities, and non-transitory computer-readable medium described herein may further include operations, features, means, or instructions for outputting, to the UE via the vCell, additional control signaling indicating that the UE may be barred from accessing the vCell based on the set of metrics failing to satisfy the one or more criteria.

Some examples of the method, network entities, and non-transitory computer-readable medium described herein may further include operations, features, means, or instructions for communicating with the UE via the first subset of serving cells of the vCell based on performing the cell attachment procedure and based on the first subset of metrics satisfying the one or more criteria and refraining from communicating with the UE via the second subset of serving cells of the vCell based on the second subset of metrics failing to satisfy the one or more criteria.

In some examples of the method, network entities, and non-transitory computer-readable medium described herein, the vCell may be configured to perform communications associated with a service and the set of serving cells of the vCell may be associated with the service, a different service, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for virtual cell (vCell) selection for multi-carrier operation in accordance with one or more aspects of the present disclosure.

FIG. 2 shows an example of a wireless communications system that supports techniques for vCell selection for multi-carrier operation in accordance with one or more aspects of the present disclosure.

FIG. 3 shows an example of a process flow that supports techniques for vCell selection for multi-carrier operation in accordance with one or more aspects of the present disclosure.

FIGS. 4 and 5 show block diagrams of devices that support techniques for vCell selection for multi-carrier operation in accordance with one or more aspects of the present disclosure.

FIG. 6 shows a block diagram of a communications manager that supports techniques for vCell selection for multi-carrier operation in accordance with one or more aspects of the present disclosure.

FIG. 7 shows a diagram of a system including a device that supports techniques for vCell selection for multi-carrier operation in accordance with one or more aspects of the present disclosure.

FIGS. 8 and 9 show block diagrams of devices that support techniques for vCell selection for multi-carrier operation in accordance with one or more aspects of the present disclosure.

FIG. 10 shows a block diagram of a communications manager that supports techniques for vCell selection for multi-carrier operation in accordance with one or more aspects of the present disclosure.

FIG. 11 shows a diagram of a system including a device that supports techniques for vCell selection for multi-carrier operation in accordance with one or more aspects of the present disclosure.

FIGS. 12 and 13 show flowcharts illustrating methods that support techniques for vCell selection for multi-carrier operation in accordance with one or more aspects of the present disclosure.

### DETAILED DESCRIPTION

In order to facilitate wireless communications within a wireless communications system, a user equipment (UE) may connect with a serving cell supported by one or more network entities (e.g., base stations). Some wireless networks, such as Fifth Generation (5G) networks, support carrier aggregation or multi-cell operation in which the UE first attaches to and communicates with a primary cell (PCell) (e.g., first component carrier (CC)), then may subsequently connect to other secondary cells (SCells) (e.g., additional CCs). That is, in some wireless networks, separate serving cells operate separately from one another, and may be accessed using separate random access channel (RACH) procedures or other attachment procedures to communicate with the respective cells. Further, in such wireless networks, the parameters for communicating with the PCell and the SCell may be separately configured or established. Such carrier aggregation/multi-cell configurations enable the UE to communicate via multiple cells, which may increase overall throughput and reliability of wireless communications. However, the UE may have relatively little control over which cells/CCs are configured at the UE. Further, performing multiple RACH procedures to attach to multiple cells/CCs may increase the latency with which the UE is able to connect and communicate with the respective cells.

Comparatively, some other wireless networks, such as Sixth Generation (6G) networks, may operate according to service-based access techniques, where resources are allocated based on different application/service needs for the UE. For example, in the context of a 6G network, a UE may attach, connect, or “subscribe” to a set of cells for different applications or services, such as authentication services, gaming services, and the like. In order to support such service-based access, such wireless networks may implement the concept of a “virtual cell” (vCell), which may include (e.g., be composed of) multiple serving cells, multiple sub-bands, multiple CCs, multiple portions of a sub-band, and the like. In such cases, the respective serving cells of a vCell may be grouped together to facilitate wireless communications for one or more applications/services (e.g., an “authentication” vCell that includes multiple serving cells that are grouped together to facilitate wireless communications for authentication services). By connecting with a vCell, the UE may communicate with multiple serving cells, thereby increasing bandwidth and reducing latency, among other advantages. As compared to previous carrier aggregation/multi-cell operation, in which the UE is required to perform separate RACH procedures to attach to PCells and SCells, the UE may be able to perform a single RACH procedure with the vCell to connect to and communicate with all the respective serving cells of the vCell.

For the purposes of the present disclosure, and in the context of a “vCell,” the terms “cell,” “serving cell,” “CC,” “sub-band,” and like terms, may be used interchangeably to refer to subsets of time/frequency resources of a vCell that may be aggregated, combined, bundled, or otherwise grouped together to form the vCell and to facilitate wireless communications via the vCell.

As will be described in further detail herein, the respective serving cells of a vCell may be supported by one or more network entities. That is, the respective serving cells of a vCell may be co-located (e.g., supported by a single network entity), or non-co-located (e.g., supported by multiple, separate network entities). In some aspects, communications parameters for accessing/communicating with a given serving cell 205 individually may be the same or different compared to communications parameters for accessing/communicating with the same serving cell 205 as part of a vCell 210.

In previous wireless networks (e.g., 5G networks), UEs may be configured to select additional serving cells (e.g., SCells) based on measurements performed on reference signals received from the respective serving cells. In particular, the UE may evaluate respective serving cells on an individualized basis (e.g., cell-by-cell basis) to determine whether or not to attach to a respective cell and/or perform a handover procedure to a new cell. However, such mechanisms may not adequately support techniques for selecting vCells. That is, evaluation of cells on an individualized basis (e.g., cell-by-cell basis) may not directly apply to selection/evaluation of vCells due to the fact that vCells include multiple serving cells that are aggregated, bundled, or otherwise grouped for wireless communications.

Accordingly, aspects of the present disclosure are directed to techniques for vCell evaluation and selection (such as in the context of 6G networks). In particular, aspects of the present disclosure are directed to signaling, rules, and conditions/configurations that enable UEs to evaluate vCells, and select vCells for cell attachment. For example, a UE may receive control signaling that indicates resources for receiving reference signals from one or more vCells. The UE may perform measurements on reference signals received from the respective vCells, and may perform a cell attachment procedure to attach/communicate with a vCell if the measurements for the respective vCell satisfies one or more access criteria for the vCell.

In some cases, the access criteria may be evaluated for each respective serving cell of the vCell, or for only a subset of the serving cells of the vCell. In other cases, the UE may evaluate access criteria for the vCell as a whole (e.g., compare composite or average measurements across all the serving cells of the vCell to access criteria). The access criteria may include conditions or thresholds associated with a relative quality and/or strength of uplink signals, downlink signals, or both, exchanged with the respective serving cells of the vCell. In some cases, the UE may attach to the vCell if the access criteria are satisfied for all the serving cells of the vCell, or satisfied for a threshold quantity/percentage of the serving cells of the vCell.

Aspects of the disclosure are initially described in the context of wireless communications systems. Additional aspects of the disclosure are described in the context of an example process flow. Aspects of the disclosure are further illustrated by and described with reference to apparatus diagrams, system diagrams, and flowcharts that relate to techniques for vCell selection for multi-carrier operation.

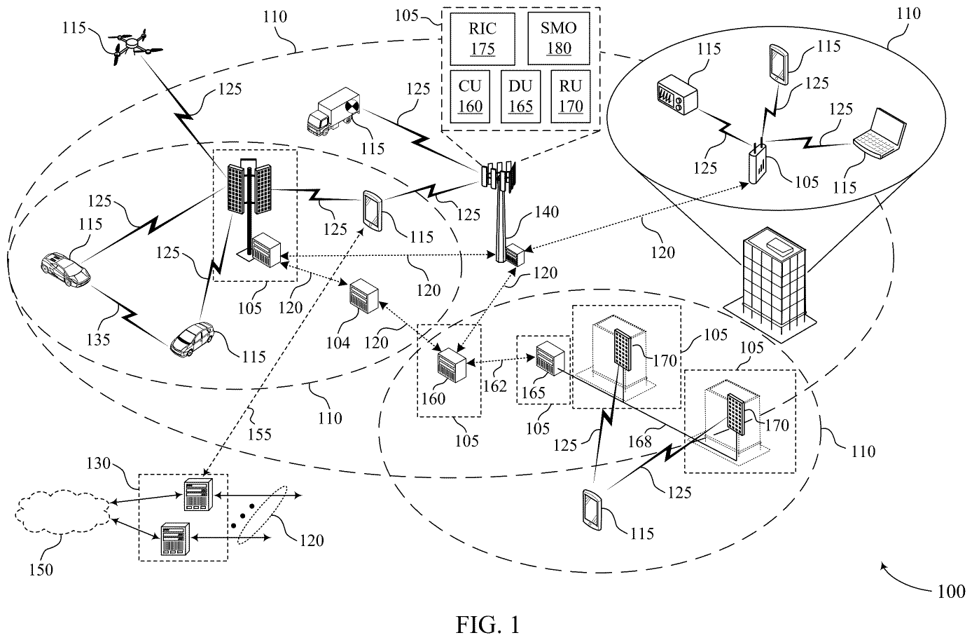

FIG. 1 shows an example of a wireless communications system 100 that supports techniques for vCell selection for multi-carrier operation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for vCell selection for multi-carrier operation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a vCell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support communications via one or more vCells. As noted previously herein, a vCell may include (e.g., be composed of) multiple serving cells, multiple sub-bands, multiple CCs, multiple portions of a sub-band, and the like. In such cases, the respective serving cells of a vCell may be grouped together to facilitate wireless communications for one or more applications/services (e.g., an “authentication” vCell that includes multiple serving cells that are grouped together to facilitate wireless communications for authentication services).

In some aspects, the wireless communications system 100 may support techniques for vCell evaluation and selection (such as in the context of 6G networks). In particular, the wireless communications system 100 may support signaling, rules, and conditions/configurations that enable UEs 115 to evaluate vCells, and select vCells for cell attachment.

For example, a UE 115 of the wireless communications system 100 may receive control signaling that indicates resources for receiving reference signals from one or more vCells. The UE 115 may perform measurements on reference signals received from the respective vCells, and may perform a cell attachment procedure to attach/communicate with a vCell if the measurements for the respective vCell satisfy one or more access criteria for the vCell. In some cases, the access criteria may be evaluated for each respective serving cell of the vCell, or for only a subset of the serving cells of the vCell. In other cases, the UE may evaluate access criteria for the vCell as a whole (e.g., compare composite or average measurements across all the serving cells of the vCell to access criteria). The access criteria may include conditions or thresholds associated with a relative quality and/or strength of uplink signals, downlink signals, or both, exchanged with the respective serving cells of the vCell. In some cases, the UE 115 may attach to the vCell if the access criteria are satisfied for all the serving cells of the vCell, or a threshold quantity/percentage of the serving cells of the vCells.

Techniques described herein may enable efficient selection (and re-selection) of vCells within a wireless network. By enabling UEs 115 to efficiently identify and select vCells, aspects of the present disclosure may enable UEs 115 to attach and communicate with vCells that include with multiple serving cells, thereby increasing bandwidth and reducing latency, among other advantages.

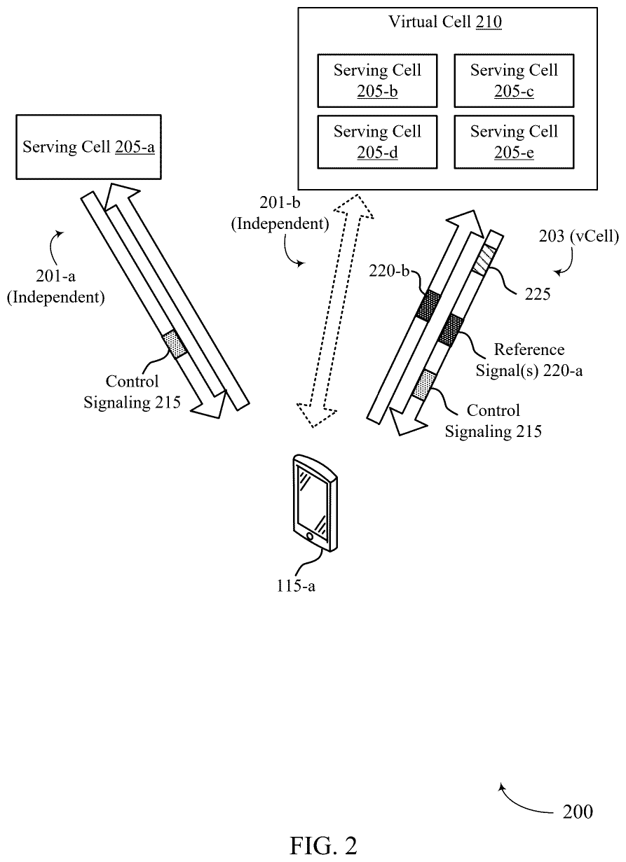

FIG. 2 shows an example of a wireless communications system 200 that supports techniques for vCell selection for multi-carrier operation in accordance with one or more aspects of the present disclosure. The wireless communications system 200 may implement, or be implemented by, aspects of the wireless communications system 100. For example, the wireless communications system 200 may include a UE 115-a, which may be an example of a UE 115, as described herein with reference to FIG. 1.

In order to perform wireless communications, the UE 115-a may communicate with a serving cell 205, such as the serving cell 205-a. A serving cell 205 may provide the primary network coverage and connectivity to the UE 115-a via a main (e.g., primary) communication link 201-a between the UE 115-a and the wireless network (e.g., the 5G NR network). As described herein, a serving cell 205 may be referred to as a sub-band, a CC (e.g., a sub-band or a portion of a sub-band), or a frequency resource. In this regard, the terms “cell,” “serving cell,” “CC,” “sub-band,” and like terms, may be used interchangeably to refer to subsets of time/frequency resources.

In some wireless communications networks, such as 5G networks, the UE 115-a may select the serving cell 205-a (e.g., a PCell) from multiple serving cells 205 according to a reference signal received power (RSRP) of each serving cell 205, among other examples. Based on selecting the serving cell 205-a, the UE 115-a may enter a connected mode (e.g., RRC connected mode). While operating in the connected mode, if the UE 115-a supports carrier aggregation (e.g., either in the uplink or downlink), a network entity 105 may configure one or more SCells in addition to the serving cell 205-a (e.g., PCell) for communication with the UE 115-a. Accordingly, if the UE 115-a is scheduled to communicate data, the network entity 105 may activate and schedule the SCells for communications with the UE 115-a.

As an illustrative example, the UE 115-a may support downlink carrier aggregation, where the UE 115-a may receive data from the serving cell 205-a and one or more SCells simultaneously. Similarly, the UE 115-a may support uplink carrier aggregation, where the UE 115-a may transmit data to the wireless network via the serving cell 205-a and one or more SCells simultaneously.

In some cases, however, the network entity 105 may configure (e.g., allocate or assign) the one or more SCells blindly. For example, the network entity 105 may configure the SCells independent of the traffic patterns at the UE 115-a, independent of the applications associated with the UE 115-a, or independent of the coverage condition of the UE 115-a (e.g., whether the UE 115-a is located at the cell-edge or cell-center), among other examples.

As such, except for reporting capabilities associated with carrier aggregations, the UE 115-a may not have control of which SCells (e.g., CCs) are configured for carrier aggregation (e.g., in both uplink and downlink), where such configured SCells may not adequately support the applications associated with the UE 115-a and may have a negative impact on the power consumption of the UE 115-a.

In some cases, it may be desirable to configure the downlink and uplink SCells (e.g., frequency resources, CCs) according to the traffic patterns of the applications associated with the UE 115-a. For example, the UE 115-a may be enabled to access one or more SCells (e.g., the carrier aggregation combination) that are based on the service metrics at the UE 115-a, based on the coverage conditions at the UE 115-a, and based on the capabilities of the UE 115-a.

That is, the UE 115-a may be enabled to perform vCell 210 selection and re-selection with downlink and uplink serving cells 205 according to various conditions at the UE 115-a. By doing so, the UE 115-a may experience an improvement in capacity (e.g., bandwidth) for downlink communications, while also experiencing an improvement in capacity as well as coverage for uplink communications. For downlink communications, improving capacity may be a primary target or goal, while for uplink communications, depending on the UE 115 coverage situation in the cell, capacity as well as coverage may considered the main key performance indicators (KPIs).

As described herein, a vCell 210 may include (e.g., be composed of) one or more serving cells 205 (e.g., multiple sub-bands, CCs, frequency resources), where each serving cell 205 of a vCell 210 may be allocated as either an uplink serving cell 205, a downlink serving cell 205, or both an uplink and downlink serving cell 205. As an illustrative example, the vCell 210 may include four serving cells 205, such as the serving cell 205-b, the serving cell 205-c, the serving cell 205-d, and the serving cell 205-e. The respective serving cells 205 of the vCell 210 may be grouped together to facilitate wireless communications for one or more applications/services. For instance, the vCell 210 may support authentication services, where the respective serving cells 205 of the vCell 210 may be combined, bundled, or otherwise grouped together to support various aspects of the authentication services.

As described previously herein, in some wireless networks, such as 5G networks, the UE 115-a may first attach to and communicate with a PCell (e.g., serving cell 205-a), then may subsequently connect to other SCells. That is, in some wireless networks, separate serving cells 205 may operate separately from one another, and must be accessed using separate RACH procedures or other attachment procedures to communicate with the respective cells. Further, in such wireless networks, the parameters for communicating with the individual serving cells 205-a may be separately configured or established.

Comparatively, some other wireless networks, such as 6G networks, may implement the concept of a vCell 210, which may include (e.g., be composed of) multiple serving cells 205, multiple sub-bands, multiple CCs, multiple portions of a sub-band, and the like. In such cases, the respective serving cells 205 of the vCell 210 may be grouped together to facilitate wireless communications for one or more applications/services. As compared to previous carrier aggregation/multi-cell operation, in which the UE 115-a is required to perform separate RACH procedures to attach to PCells and SCells, the UE 115-a may be able to perform a single RACH procedure with the vCell 210 to connect to and communicate with all the respective serving cells 205 of the vCell 210.

In this regard, the serving cell 205-a may be an example of a “standalone” serving cell 205-a that may or may not be a part of a vCell 210, and which is accessible via a communication link 201-a. Comparatively, the vCell 210 may include a group of serving cells 205-b, 205-c, 205-d, 205-e that are aggregated, bundled, or otherwise grouped together to facilitate wireless communications via one or more communication links, such as the communication link 203.

Furthermore, in addition to facilitating communications as part of the vCell 210, the respective serving cells 205 of the vCell 210 may also support or otherwise facilitate wireless communications with the UE 115 that are separate or independent from the vCell 210 (e.g., via a communication link 201-b for “independent” communications). That is, each of the respective serving cells 205 may be accessible individually (e.g., as standalone serving cells 205, such as in 5G), and/or as part of a vCell 210 (e.g., as a group of serving cells 205, such as in 6G). For example, the UE 115-a may communicate with the serving cell 205-d as part of the vCell 210 via the communication link 203, and may additionally and/or alternatively communicate with the same serving cell 205-d separately/independently from the vCell 210 via the communication link 201-b.

In some examples, each of the serving cells 205 of the vCell 210 may be operated by a single network entity 105 (e.g., co-located). In other examples, a first subset of the serving cells 205 of the vCell 210 may be operated by a first network entity 105 and a second subset of the serving cells 205 of the vCell 210 may be operated by a second network entity 105 (e.g., non-co-located).

In such cases, one or more vCells 210 may be formed (e.g., allocated) each having a different combination of serving cells 205. In some examples, the network entity 105 may form the vCell 210, where, to form the vCell 210, the network entity 105 may select the serving cells 205 and indicate the vCell 210 to the UE 115-a. Alternatively, the network entity 105 may indicate “candidate” serving cells 205 which may be bundled/grouped to form a vCell 210, where the UE 115-a may form the vCell 210 by selecting a set of serving cells 205 from the set of candidate serving cells 205. Accordingly, a complete vCell 210, one either formed by the UE 115-a or the network entity 105, may include serving cells 205 that enable the UE 115-a to access the vCell 210 (e.g., include uplink and downlink serving cells 205). As such, if each step of a RACH procedure could be performed using the serving cells 205 of a vCell 210, then the vCell 210 is complete.

As part of UE-initiated access (e.g., in uplink), the UE 115-a may be aware of the current service metrics and coverage conditions, such that the UE 115-a may select one of the formed vCells 210 accordingly (e.g., select a carrier aggregation combination). Additionally, for downlink, the UE 115-a may utilize a paging procedure to identify and select one of the formed vCells 210.

Accordingly, such service-based access may provide a universal access solution for different tiers of UEs 115. For example, a first tier of UEs 115 may aggregate an increased quantity of serving cells 205 within a vCell 210 (e.g., an increased quantity of bandwidth), while a second tier of UEs 115 may select a single serving cell 205 (e.g., a limited BW) for communications. As such, if a network entity 105 advertises different vCells 210, each including a different quantity of downlink and uplink serving cells 205, each UE 115 can select a vCell 210 according to the service metrics, traffic patterns, coverage conditions, and capabilities, among other examples.

In some aspects, the use of vCells 210 may reduce the latency with which the UE 115-a is able to connect and communicate with the respective serving cells 205 of the vCell 210. That is, the configuration of the SCells in conventional carrier aggregation contexts may increase latency. In particular, in the context of conventional carrier aggregation/multi-cell operation, downlink and uplink SCell configurations may account for a relatively large portion of latency to get the SCells to an operational state. As an illustrative example, the latency associated with downlink SCell configuration latency may account for approximately 43% of the total latency, while the latency for uplink SCell configuration may account for approximately about 83% of the total latency.

For instance, to configure the SCells in conventional downlink carrier aggregation, the UE 115-a may transmit a first RRC message (e.g., RRC Setup Comp) to request the configuration of one or more SCells. In response, the network entity 105 may transmit a second RRC message (e.g., RRC Reconfig) including the carrier aggregation configuration that configures one or more SCells, where the UE 115-a may transmit a third RRC message (e.g., RRC Reconfig Complete) indicating that the UE 115-a has received the carrier aggregation configuration.

In response to receiving the third RRC message, the network entity 105 may transmit a MAC control element (MAC-CE) activating a first SCell of the one or more SCells indicated in the carrier aggregation configuration. Accordingly, the UE 115-a may perform channel measurements on the first SCell and transmit channel state feedback (e.g., channel state information (CSI)) to the network entity 105. If the channel state feedback of the first SCell is sufficient, the network entity 105 may schedule a data (e.g., a physical downlink shared channel (PDSCH) transmission) via the first SCell, such that the UE 115-a may receive the data via the first SCell.

In such cases, however, the UE 115-a may experience an increased configuration delay between the transmission of the first RRC message and the reception of the second RRC message, experience an activation delay between transmission of the third RRC message and reception of the MAC-CE, and experience a scheduling delay between the transmission of the channel state feedback and the reception of the data.

Similarly, to configure the SCells in conventional uplink carrier aggregation, the UE 115-a may transmit a first RRC message (e.g., RRC Setup Comp) to request the configuration of one or more SCells. In response, the network entity 105 may transmit a second RRC message (e.g., RRC Reconfig, event A1) and transmit a third RRC message (e.g., RRC Reconfig) that includes the carrier aggregation configuration that configures one or more SCells.

In response to receiving the carrier aggregation configuration, the UE 115-a may transmit a buffer status report (BSR) indicating a quantity of data to be transmitted from the UE 115-a. Based on receiving the BSR, the network entity 105 may transmit a MAC-CE activating a first SCell of the one or more SCells indicated in the carrier aggregation configuration. The network entity 105 may also transmit resources via which the UE 115-a may transmit the data (e.g., physical uplink shared channel (PUSCH)).

In such cases, however, the UE 115-a may experience an increased configuration delay between the transmission of the first RRC message and the reception of the second and third RRC messages, experience an activation delay between reception of the third RRC message and reception of the MAC-CE, and experience a scheduling delay between reception of MAC-CE and the reception of the resources for the data.

As such, by allowing the UE 115-a to select the vCell 210 (e.g., selecting a combination of serving cells 205), the UE 115-a may experience a reduction to the overall latency. For example, the UE 115-a and the network entity 105 may communicate the measurements and signaling related to SCell configuration in parallel (e.g., via multiple serving cells 205) and as part of cell selection. Accordingly, with access to the vCell 210, the UE 115-a may be ready to communicate (e.g., transmit or receive) via each serving cell 205 within a vCell 210 in response to entering the connected state (e.g., the RRC connected state).

In some cases, the UE 115-a may utilize the vCell 210 during a RACH procedure (e.g., initial access, access procedures) to reduce latency and improve efficiency. For example, the UE 115-a (or the network entity 105) may leverage each serving cell 205 (e.g., each band) of a vCell 210 starting from the RACH procedure, where the UE 115-a may select a vCell 210 that includes serving cells 205 associated with improved uplink communications and include serving cells 205 associated with improved downlink communications.

As an illustrative example, the UE 115-a may transmit uplink messages (e.g., message 1, message 3, or message A) of the RACH procedure using a first set of serving cells 205 of the vCell 210 that are associated with frequency division duplexing (FDD) (e.g., lower frequency bands), while the UE 115-a may receive downlink messages (e.g., message 2, message 4, or message B) of the RACH procedure using a second set of serving cells of the vCell 210 that are associated with time division duplexing (TDD).

In such cases, FDD bands may be more efficient for uplink communications rather than TDD bands due to a smaller subcarrier spacing of FDD bands (e.g., improved coverage areas), due to unrestricted slot formats allowing for lower latency and more efficient repetition handling, and due to increased network energy efficiency while monitoring for the uplink messages (e.g., RACH monitoring in FDD verse TDD), among other examples.

Additionally, in some cases, the FDD bands may be more efficient for uplink communications rather than TDD bands due to the UE 115-a being able to achieve a relatively increased output power in FDD bands relative to TDD bands, which may depend on a transmission chain of the UE 115-a (e.g., 1 power amplifier (PA) associated with 26 dBm gain in FDD vs. two PAs associated with 23 dBm gain each in TDD). Further PAs in relatively higher bands (e.g., TDD bands) may not be efficient. Accordingly, selecting a transmission chain may become increasingly complex for a UE 115 including 4 transmission chains (e.g., 4Tx UEs).

Further, in both uplink and downlink communications, the UE 115-a may benefit from flexibility in selecting the serving cells 205 of the vCell 210, which may reduce complexity of radio frequency management, affect placement of antennas and managing exposure, and affect the total power considerations for uplink communications. For example, because power class is defined as the aggregated power across serving cells 205 (e.g., sub-bands or bands), the UE 115-a may decide which bands to aggregate to be able to more efficiently handle exposures (e.g., maximum permissible exposures (MPEs) or Specific Absorption Rate).

As noted previously herein, in some previous wireless networks (e.g., 5G networks), UEs 115 may be configured to select additional serving cells 205 (e.g., SCells) based on measurements performed on reference signals received from the respective serving cells 205. In particular, the UE 115-a may evaluate respective serving cells 205 on an individualized basis (e.g., cell-by-cell basis) to determine whether or not to attach to a respective cell and/or perform a handover procedure to a new cell.

For example, in 5G networks, the UE 115—may calculate/evaluate cell selection criteria based on RSRP measurements of reference signals (e.g., SSBs) received from a candidate serving cell 205. A candidate serving cell may be an “acceptable” cell for cell attachment if (1) the cell is not barred for cell attachment, and (2) cell selection criteria for the cell are satisfied/fulfilled. Cell selection criteria (e.g., criteria for accessing a serving cell) may be associated with signal strength metrics, signal quality metrics, and the like. Example cell selection criteria are illustrated via Equation 1 and Equation 2 below:

$$Srxlev = {Q}_{rxlevmeas} - {Q}_{rxlevmin} - {P}_{compensation} > 0 \qquad ( 1 )$$

$$Squal = {Q}_{qualmeas} - {Q}_{qualmin} > 0 \qquad ( 2 )$$

where Srxlev and Squal are cell quality metrics, Qᵣₓₗₑᵥₘₑₐₛ defines measured cell RSRP measurements, Qᵣₓₗₑᵥₘᵢₙ defines a minimum cell RSRP threshold, Qᵣₓₗₑᵥₘₑₐₛ defines measured cell RSRQ measurements (downlink), Qᵣₓₗₑᵥₘᵢₙ defines a minimum cell RSRP threshold, and P_{compensation} is a compensation metric associated with uplink. The term P_{compensation}=0 for Frequency Range 2 (FR2), and P_{compensation}=max(P_{EMAX1}−P_{powerClass}, 0) for FR1 (or max(P_{EMAX1}−P_{powerclass}, 0)−(min(P_{EMAX2}, P_{powerclass})−min(P_{EMAX1},P_{powerclass}) for FR1).

As noted herein, previous mechanisms for selecting serving cells on an individualized basis (e.g., cell-by-cell basis) may not adequately support techniques for selecting vCells 210. That is, evaluation of serving cells 205 on an individualized basis (e.g., cell-by-cell basis) may not directly apply to selection/evaluation of vCells 210 due to the fact that vCells 210 include multiple serving cells 205 that are aggregated, bundled, or otherwise grouped for wireless communications. That is, a vCell 210 may include multiple serving cells 205 (e.g., multiple sub-bands, multiple CCs, etc.), where all or a subset of the serving cells 205 may include reference signals (e.g., cell-defining SSBs (CD-SSBs), non-cell-defining-SSBs (NCD-SSBs), etc.) that may be measured for cell selection/re-selection.

Accordingly, the wireless communications system 200 may support techniques for vCell 210 evaluation and selection (such as in the context of 6G networks). In particular, the wireless communications system 200 may support signaling, rules, and conditions/configurations that enable the UE 115-a to evaluate vCells 210, and select vCells 210 for cell attachment. That is, aspects of the present disclosure are directed to conditions and configurations that may be used to define cell selection criteria for accessing/selecting a vCell 210, as well as configurations that define are used to identify “barred” vCells 210. For the purposes of the present disclosure, a vCell 210 may or may not exhibit duplexing symmetry between serving cells 205 (e.g., sub-bands, CCs) that form a vCell 210. For example, the vCell 210 may include three serving cells 205 (e.g., three sub-bands, three CCs), where (1) two of the serving cells 205 (e.g., two of the sub-bands, two of the CCs) are downlink and one is uplink (or vice versa), (2) one serving cell 205 is downlink-only, one is uplink-only, and one is both downlink/uplink, etc.

For example, referring to FIG. 2, the UE 115-a may receive control signaling 215 that indicates a set of resources for receiving reference signals 220 from the vCell 210. The control signaling 215 may include RRC, DCI, MAC-CE, SI (e.g., SIB), or any combination thereof. Moreover, the control signaling 215 may be received from the serving cell 205-a, the vCell 210, or both. For example, the UE 115-b may receive control signaling 215-a from the serving cell 205-a (e.g., PCell), control signaling from the vCell 210 (e.g., SIB), or both.

As noted previously herein, the vCell 210 may include a set of serving cells 205 that are aggregated, bundled, or otherwise grouped together to facilitate wireless communications. In some aspects, the vCell 210 may be associated with (e.g., support) a specific service (e.g., authentication service, gaming service, etc.), where each of the serving cells 205 of the vCell 210 are associated with the same service (and/or other services). For instance, in some 6G networks, serving cells 205 may be designated for certain services by the network (e.g., serving cells 205 may only be used for specific, indicates services/applications). Similarly, the same concept may be applied for vCells 210, where vCells 210 may only be used for specific services/applications. In cases where a vCell 210 is designated/reserved for a specific service, the constituent serving cells 205 of the vCell 210 may have the same service designation as indicated for the vCell 210. In other cases, the constituent serving cells 205 may be indicated for either the same set of services or different services.

The respective serving cells 205 of the vCell 210 may be supported by one or more network entities. That is, the respective serving cells 205 of the vCell 210 may be co-located (e.g., supported by a single network entity), or non-co-located (e.g., supported by multiple, separate network entities).

Moreover, as described previously herein, each of the serving cells 205 of the vCell 210 (and/or the serving cell 205-a) may be accessed individually and/or as part of a vCell 210. In some aspects, communications parameters for accessing/communicating with a given serving cell 205 individually may be the same or different compared to communications parameters for accessing/communicating with the same serving cell 205 as part of a vCell 210.

In some cases, the control signaling 215 may include additional or alternative information that is usable by the UE 115-a for evaluating and selecting the vCell 210. For example, the control signaling 215 may indicate one or more criteria (e.g., access criteria) for accessing the vCell 210. In some cases, the access criteria may be evaluated for each respective serving cell of the vCell 210, or for only a subset of the serving cells of the vCell 210. In other cases, the UE 115-a may evaluate access criteria for the vCell 210 as a whole (e.g., compare composite or average measurements across all or a portion of the serving cells 205 of the vCell 210 to access criteria). The access criteria may include conditions or thresholds associated with a relative quality and/or strength of uplink signals, downlink signals, or both, exchanged with the respective serving cells of the vCell 210.

Further, the control signaling 215 may indicate rules or conditions that indicate whether the UE 115-a may access/select the vCell 210, or whether the UE 115-a is barred from accessing the vCell 210. For instance, the UE 115-a may attach to the vCell 210 if the access criteria are satisfied for all the serving cells of the vCell 210, or satisfied only for a threshold quantity/percentage of the serving cells 205 of the vCell 210. In such cases, the control signaling 215 may indicate the threshold quantity or percentage of serving cells 205 of the vCell 210 that are expected to satisfy the criteria in order for the UE 115-a to select/access the vCell 210. Moreover, the control signaling 215 may indicate some serving cells 205 of the vCell 210 that are required to satisfy the criteria to access the vCell 210 (e.g., mandatory cells), where other cells of the vCell 210 may or may not have to satisfy the criteria in order for the UE 115-a to access the vCell 210 (e.g., “optional” cells).

The UE 115-a may receive one or more reference signals 220-a (e.g., SSBs, CD-SSBs, NCD-SSBs, etc.) from one or more serving cells 205 of the vCell 210. Depending on the access criteria, UE 115-a may monitor for (and receive) reference signals 220-a from all the serving cells 205 of the vCell 210, or only a subset of the serving cells 205 of the vCell 210. The UE 115-a may receive the reference signals 220-a via the resources indicated via the control signaling 215. The UE 115-a may perform measurements (e.g., RSRP measurements, RSRQ measurements) on the reference signals 220-a received from the vCell 210. As noted previously herein, the measurements may be used to evaluate satisfaction (or lack thereof) of the access criteria in order to determine whether the UE 115-a is able to access/select the vCell 210 (or whether the UE 115-a is barred from accessing the vCell 210). As such, the UE 115-a may perform the measurements based on the respective access criteria for accessing the vCell 210, which may be indicated via the control signaling 215.

Similarly, in order to evaluate the quality of uplink communications between the UE 115-a and the vCell 210, the UE 115-a may transmit reference signals 220-b to the vCell 210 (e.g., to one or more serving cells 205 of the vCell 210). Similar to the downlink reference signals 220-a received from the vCell 210, the uplink reference signals 220-b may be used to evaluate whether the access criteria for accessing the vCell 210 are satisfied. That is, the vCell 210 may be configured to perform measurements on the reference signals 220-b, where the measurements may be used to further evaluate whether or not the access criteria for accessing the vCell 210 are satisfied.

In such cases, the UE 115-a may receive a message 225 (e.g., control message, measurement report) from the vCell 210. The message 225 may indicate one or more characteristics associated with the reference signals 220-b received from the UE 115-a via the set of serving cells 205 of the vCell 210. For example, the message 225 may indicate the measurements performed on the uplink reference signals 220-b, and/or an evaluation of such measurements.

In some cases, the message 225 may include cell barring information (e.g., information that indicates whether or not the UE 115-a is barred from accessing/selecting the vCell 210). For example, in cases where the measurements performed by the vCell 210 on the uplink reference signals 220-b fail to satisfy the access criteria, the vCell 210 may indicate (via the message 225) that the UE 115-a is barred from accessing the vCell 210. In some cases, the network (e.g., via message 225) may indicate that vCell 210 is barred via one bit of information. The information bit may be indicated via SSB or SIB in all (or a subset) of the serving cells 205 of the vCell 210.

The UE 115-a may evaluate whether or not the access criteria for accessing the vCell 210 are satisfied or not. The UE 115-a may evaluate the cell access criteria based on receiving the control signaling 215, performing the measurements on the reference signals 220-a, receiving the message 225 (e.g., measurements/characteristics, cell barring information), or any combination thereof.

In some cases, access criteria may be defined for specific serving cells of the vCell 210 (e.g., individual criteria), and/or for the vCell 210 as a whole (e.g., composite criteria). For example, in some cases, different criteria may be defined for different serving cells of the vCell 210 based on characteristics of the respective serving cells 205, such as the FR of the respective serving cell 205 (e.g., first set of criteria for serving cells 205 in FR1, second set of criteria for serving cells 205 in FR2). In other cases where the UE 115-a is to check the access for each respective serving cell 205 of the vCell 210 separately, the criteria may be dependent on whether the respective serving cell 205 of the vCell 210 is downlink-only, uplink-only, or downlink and uplink. In cases of an uplink-only serving cell 205, the serving cell 205 on which the UE 115-a has to perform measurement related to the uplink-only serving cell 205 may not be within the vCell 210. Alternatively, such a serving cell 205 may not have any downlink resources (e.g., downlink reference signals) for measurement associated with it, in which case information related to the downlink-only serving cell may be derived based on artificial intelligence (AI)/machine learning (ML) techniques, and or based on feedback from the vCell 210 (e.g., message 225).

In some cases where the access criteria for the vCell 210 are to checked separately and independently for each serving cell 205 of the vCell 210, the UE 115-b may determine Q_{rxlevmeas,i}, which indicates the measured Rx level value (e.g., RSRP) of the reference signals 220-a on the i^{th} serving cell 205 of the vCell 210: The UE 115-a may measure Qᵣₓₗₑᵥₘₑₐₛ for each serving cell 205 of the vCell 210 that transmits SSBs or other reference signals 220-a. Further, the UE 115-a may compare Q_{rxlevmeas,i}, to Q_{rxlevmin,i}, which is the minimum required Rx level for the i^{th} serving cell 205 of the vCell 210 (e.g., Q_{rxlevmin,i} is an access criteria for accessing the vCell 210 and/or the i^{th} serving cell 205 of the vCell 210). In some cases, the network may indicate Q_{rxlevmin,i} for each serving cell 205 of the vCell 210 (e.g., via the control signaling 215) that includes downlink reference signals 220-a for measurement. Additionally, or alternatively, the network may configure a common Q_{rxlevmin,i} value that may be common across some subset of serving cells of the vCell 210 (e.g., common Q_{rxlevmin,i} for all serving cells 205 that fall within the same band or FR). This same applies may also be applied to other measurements and/or access criteria, such as Q_{qualmeas} and Q_{qualmin}.

In some aspects, in cases where the access criteria are to be checked separately and independently for each serving cell 205 of the vCell 210, the UE 115-a may be configured to calculate P_{compensation} per SB separately for each individual serving cell 205 of the vCell 210 (for uplink-only as well as uplink+downlink serving cells 205). The term P_{EMAX,i} may indicate the maximum uplink power permitted to UEs 115 by the network, and may be indicated via SIB (e.g., SIB1 for a camped cell, and via OSI for neighboring cells). The term P_{EMAX,i} may be given for the band for the i^{th} serving cell 205. Similarly, P_{PowerClass} may be defined as the power class of the UE 115-a in the band in which the i^{th} is located, or power class of the UE 115-a in a band combination formed by all uplink serving cells 205 of the vCell 210, or power class of the UE 115-a in a band combination formed by all uplink serving cells 205 of the vCell 210 associated with a RACH configuration (which can be used for initial access procedure or at least the uplink portion of the initial access procedure).

Examples for serving cell 205 specific selection criteria for serving cells 205 of the vCell 210 with both downlink and uplink (or uplink-only serving cells 205) are illustrated via Equation 1 and Equation 2 above (with subscript i indicating criteria for the i^{th} serving cell 205 dropped).

In additional or alternative cases, vCell-specific selection criteria (e.g., composite criteria) may be defined, where the UE 115-a evaluates one set of metrics/criteria for the entire vCell 210 (as opposed to evaluating criteria for the respective serving cells 205 separately/independently). In such cases, inputs to the access criteria evaluation may include measurements and configuration parameters (e.g., criteria) associated with multiple downlink-only serving cells 205, uplink-only serving cells 205, and/or downlink+uplink serving cells 205. However, as in the serving cell 2-5=specific evaluation cases, the measurements and configurations may still be defined per-serving cell 205, and/or some measurements/configuration parameters may be defined per vCell 210 (e.g., applied to different SBs/cells/CCs)

Examples of vCell-specific selection criteria (e.g., composite criteria) are illustrated in Equation 3 and Equation 4 below:

$$( {\sum }_{i ∈ DL SBs} ( {Q}_{rxlevmeas , i} - {Q}_{rxlevmin , i} ) ) - ( {\sum }_{i ∈ UL SBs} {P}_{compensation , i} ) > 0 \qquad ( 3 )$$

$$( {\sum }_{i ∈ particular DL SBs} {Q}_{rxlevmeas , i} ) - {Q}_{rxlevmin ,} - ( max ( {\sum }_{i ∈ particular UL SBs} ( {P}_{EMAX 1 , i} - {P}_{powerclass} ) , 0 ) ) > 0 \qquad ( 4 )$$

where Q_{rxlevmin, i} is a serving cell-specific threshold, and Qᵣₓₗₑᵥₘᵢₙ is vCell-specific threshold in this example. As noted previously herein, different equations (e.g., different equations for evaluating access criteria) may be defined for downlink-only, uplink-only and downlink+uplink serving cells 205 of the vCell 210.

In some aspects, the selection/access criteria for accessing the vCell 210 (both serving-cell specific criteria and vCell-specific criteria) may be signaled to the UE 115-a, pre-defined by the network (e.g., hard-coded within relevant standards or specifications associated with the network), or both. For example, the equations/functions for evaluating access criteria for the vCell 210, threshold and/or coefficients for such functions, and information as to which serving cells 205 of the vCell 210 are to be included when evaluating vCell-specific selection criteria, may be signaled and/or pre-configured by the network, such as via a list or bitmap.

Additionally, or alternatively, some functions/parameters may be hard-coded into relevant standards/specifications, while others may be indicated by the network on a per-serving cell 205 and/or per-vCell 210 basis. For example, the functions/equations for evaluating access criteria for the vCell 210 may be pre-configured or specified, while the coefficients and thresholds may be signaled or otherwise indicated to the UE 115-a. For instance, in some cases, the network (e.g., serving cell 205-a, vCell 210) may broadcast the selection/access criteria (both serving cell-specific and vCell-specific criteria) for accessing the vCell 210 via an indication in a SIB sent by a serving cell 205 of the vCell 210 (and/or via a SIB sent on another serving cell 205 that is not associated with the vCell 210). Further, such information may be transmitted to the UE 115-a in a dedicated manner when the UE 115-a is in a connected mode, which may be similar to indicating SCG parameters via MCG in dual connectivity.

In some aspects, in the context of serving cell 205 specific access criteria (e.g., when access criteria are evaluated individually/separately for the respective serving cells 205 of the vCell 210), the vCell 210 may be considered acceptable (e.g., not barred) if the metrics for all the serving cells 205 of the vCell 210 are satisfied, or when the criteria for a subset of the serving cells 205 of the vCell 210 are satisfied. Such rules or configurations may be hard-coded in relevant standards/specifications, and/or may be signaled/indicated to the UE 115-a.

For example, the network may indicate (via the control signaling 215) the minimum quantity or percentage of serving cells 205 of the vCell 210 that should satisfy the access criteria in order for the UE 115-a to be able to access the vCell 210 (where the minimum quantity/percentage may be defined for downlink serving cells 205 and uplink serving cells 205 either jointly or separately). For example, in order for the UE 115-a to access the vCell 210, the criteria for all downlink serving cells 205 may have to be satisfied, where the criteria for only X quantity or percentage of uplink serving cells 205 may have to be satisfied.

Moreover, the control signaling 215 may indicate some serving cells 205 of the vCell 210 that are required to satisfy the criteria to access the vCell 210 (e.g., mandatory cells), where other cells of the vCell 210 may or may not have to satisfy the criteria in order for the UE 115-a to access the vCell 210 (e.g., “optional” cells). That is, some indicated serving cells 205 of the vCell 210 may be required to satisfy the access criteria for the vCell 210 to be accessible, while such a requirement may not be applied to some other serving cells 205.

In cases where the access criteria for accessing the vCell 210 are satisfied, the UE 115-a may determine that the vCell 210 is available for cell attachment, and may perform a cell attachment procedure to connect and communicate with the respective serving cells 205 of the vCell 210. For example, as part of the cell attachment procedure, the UE 115-a and one or more serving cells of the vCell 210 may exchange signaling as part of a RACH procedure.

Conversely, in cases where the access criteria for accessing the vCell 210 are not satisfied, the UE 115-a may determine that the vCell 210 is not available for cell attachment (e.g., the vCell 210 is barred, or the UE 115-a is barred from accessing the vCell 210). In such cases, the UE 115-a may continue to search for other vCells 210 that are not barred.

In some cases, the UE 115-a may be barred from accessing a subset of serving cells of the vCell 210 even when the UE 115-a is otherwise able to access the remainder of the vCell 210. That is, some serving cells of the vCell 210 may be barred, while others are accessible. In such cases, the UE 115-a may be configured to perform the cell attachment procedure at cell attachment operation 345 (and perform signaling operation 350) with only a subset of serving cells of the vCell 210.

Moreover, as noted previously herein, the respective serving cells of the vCell 210 (and the serving cell 205-a) may be accessible individually and/or as part of a vCell 210. In such cases, the UE 115-a may be able to access some of the serving cells of the vCell 210 individually (e.g., separate from the vCell 210) even in cases where the UE 115-a is barred from accessing the vCell 210 itself.

Stated differently, the vCell 210 and its constituent serving cells 205 may be barred jointly (e.g., one message 225/indication with cell barring information is sent for the vCell 210 and applies to all of the constituent serving cells 205) or the barring of a vCell 210 and the barring of the constituent serving cells 205 may be different from each other and interpreted differently. For example, the vCell 210 may be barred, while the constituent serving cells 205 of the vCell 210 may not be barred, and may therefore be accessed independently/separately from the vCell 210 (e.g., each serving cell 205 can be accessible still like a separate cell, despite the vCell 210 being barred). This may occur in cases where the network might want to have separate cells for some amount of time, or to bar a specific vCell 210 while some of the serving cells 205 of the vCell 210 can be used for another vCell 210.

Conversely, a serving cell 205 of the vCell 210 may be barred while the vCell 210 itself is not barred. For instance, the UE 115-a may be able to access the vCell 210, but may not be able to access the individual serving cell 205-e. In such cases, the UE 115-a may considered the vCell 210 as being barred (due to the fact that at least one constituent serving cell 205 of the vCell 210 is barred). In other cases, the UE 115-a may assume that the constituent serving cells 205 that are barred are not accessible but that the rest of the serving cells 205 forming the same vCell 210 are still accessible (in a sense, a portion of the vCell 210 is still accessible). In this example, the UE 115-a may only use or otherwise access the subset of the serving cells 205 of the vCell 210 that are not barred.

In cases where the message 225 includes cell barring information (e.g., one bit that indicates whether or not the vCell 210 is barred), the message 225 may or may not indicate whether the individual serving cells 205 of the vCell 210 are barred. That is, the respective serving cells 205 of the vCell 210 may still operate as separate/independent cells if they are not barred themselves individually.

To summarize, the vCell 210 and its constituent serving cells 205 may be barred collectively (e.g., jointly) and/or separately/individually. Rules for vCell 210 barring may be dependent on the barring of the constituent serving cells 205. For instance, the vCell 210 may be barred if: (1) all serving cells 205 of the vCell 210 are barred, (2) a subset (e.g., minimum quantity/percentage) of the serving cells 205 of the vCell 210 are barred, (3) specific “mandatory” serving cells 205 of the vCell 210 are barred, and/or (4) if any single serving cell 205 of the vCell 210 is barred. Which rule is to be applied may be pre-defined in relevant standards/specification, and/or may be signaled or otherwise indicated to the UE 115-a (e.g., .via SIB, or in a dedicated manner). For instance, the control signaling 215 may indicate a list of “mandatory” serving cells 205, and/or may indicate the threshold quantity/percentage of serving cells 205 that are required to satisfy the access criteria.

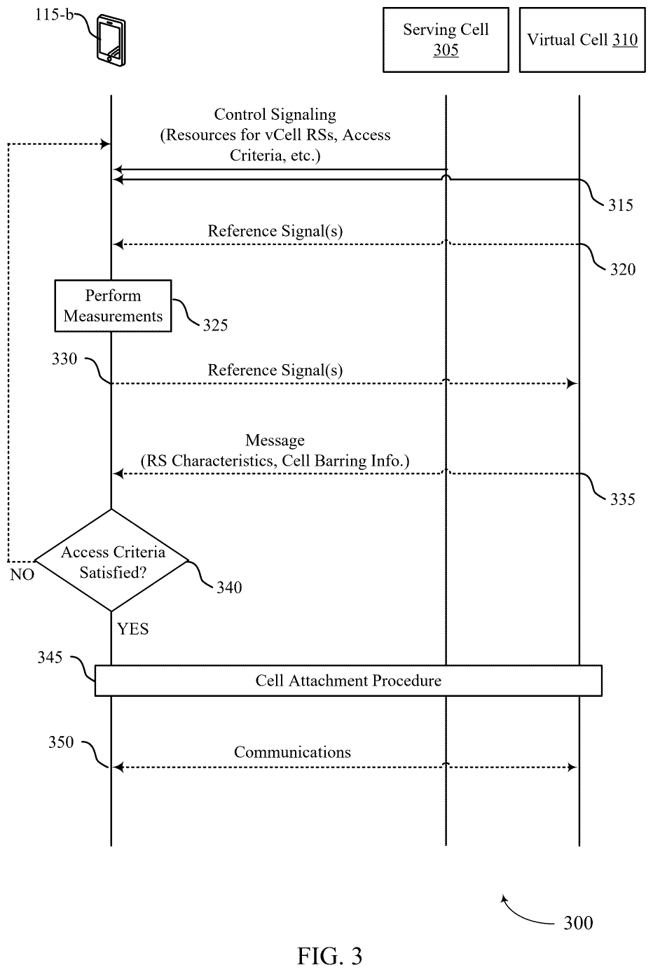

FIG. 3 shows an example of a process flow 300 that supports techniques for vCell selection for multi-carrier operation in accordance with one or more aspects of the present disclosure. Aspects of the process flow 300 may implement, or be implemented by, aspects of the wireless communications system 100, the wireless communications system 200, or both. For example, the process flow 300 may support signaling and configurations used for vCell evaluation and selection.

The process flow 300 includes a UE 115-b, a serving cell 305, and a vCell 310, which may be examples of cells and wireless devices as described herein. For example, the UE 115-b, the serving cell 305, and the vCell 310 illustrated in FIG. 3 may include examples of the UE 115-a, the serving cell 205-a, and the vCell 210, respectively, as illustrated in FIG. 2. In this regard, the serving cell 305 may be an example of a “standalone” cell, and the vCell 310 may include a set of serving cells (e.g., set of sub-bands, set of CCs, etc.) that are aggregated, bundled, or otherwise grouped to facilitate wireless communications.

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 315, the UE 115-b may receive control signaling that indicates a set of resources for receiving reference signals from the vCell 310. The control signaling may include RRC, DCI, MAC-CE, SI (e.g., SIB), or any combination thereof. Moreover, the control signaling may be received from the serving cell 305, the vCell 310, or both.

As noted previously herein, the vCell 310 may include a set of serving cells that are aggregated, bundled, or otherwise grouped together to facilitate wireless communications. In some aspects, the vCell 310 may be associated with (e.g., support) a specific service (e.g., authentication service, gaming service, etc.), where each of the serving cells of the vCell 310 are associated with the same service (and/or other services). The respective serving cells of the vCell 310 may be supported by one or more network entities. That is, the respective serving cells of the vCell 310 may be co-located (e.g., supported by a single network entity), or non-co-located (e.g., supported by multiple, separate network entities).

Moreover, as described previously herein, each of the serving cells of the vCell 310 (and/or the serving cell 305) may be accessed individually and/or as part of a vCell 310. In some aspects, communications parameters for accessing/communicating with a given serving cell 205 individually may be the same or different compared to communications parameters for accessing/communicating with the same serving cell 205 as part of a vCell 210.

In some cases, the control signaling may include additional or alternative information that is usable by the UE 115-b for evaluating and selecting the vCell 310. For example, the control signaling may indicate one or more criteria (e.g., access criteria) for accessing the vCell 310. In some cases, the access criteria may be evaluated for each respective serving cell of the vCell 310, or for only a subset of the serving cells of the vCell 310. The access criteria may include conditions or thresholds associated with a relative quality and/or strength of uplink signals, downlink signals, or both, exchanged with the respective serving cells of the vCell 310.

In some cases, access criteria may be defined for specific serving cells of the vCell 310 (e.g., individual criteria), and/or for the vCell 310 as a whole (e.g., composite criteria). For example, in some cases, different criteria may be defined for different serving cells of the vCell 310 based on characteristics of the respective serving cells, such as the FR of the respective serving cell (e.g., first set of criteria for serving cells in FR1, second set of criteria for serving cells in FR2).

Further, the control signaling may indicate rules or conditions that indicate whether the UE 115-b may access/select the vCell 310, or whether the UE 115-b is barred from accessing the vCell 310. For instance, the UE 115-b may attach to the vCell 310 if the access criteria are satisfied for all the serving cells of the vCell 310, or satisfied only for a threshold quantity/percentage of the serving cells of the vCell 310. In such cases, the control signaling may indicate the threshold quantity or percentage of serving cells of the vCell 310 that are expected to satisfy the criteria in order for the UE 115-b to select/access the vCell 310. Moreover, the control signaling may indicate some serving cells of the vCell 310 that are required to satisfy the criteria to access the vCell 310 (e.g., mandatory cells), where other cells of the vCell 310 may or may not have to satisfy the criteria in order for the UE 115-b to access the vCell 310 (e.g., “optional” cells).

At signaling operation 320, the UE 115-b may receive one or more reference signals (e.g., SSBs, CD-SSBs, NCD-SSBs, etc.) from one or more serving cells of the vCell 310. Depending on the access criteria, UE 115-a may monitor for (and receive) reference signals from all the serving cells of the vCell 310, or only a subset of the serving cells of the vCell 310. The UE 115-b may receive the reference signals of the signaling operation 320 via the resources indicated via the signaling operation 315.

At measurement operation 325, the UE 115-b may perform measurements (e.g., RSRP measurements, RSRQ measurements) on the reference signals received from the vCell via signaling operation 320. As noted previously herein, the measurements performed via the measurement operation 325 may be used to determine whether the UE 115-b is able to access/select the vCell 310 (or whether the UE 115-b is barred from accessing the vCell 310). As such, the UE 115-b may perform the measurements based on the respective access criteria for accessing the vCell 310, which may be indicated via the signaling operation 315.

At signaling operation 330, the UE 115-b may transmit reference signals to the vCell 310 (e.g., to one or more serving cells of the vCell 310). Similar to the downlink reference signals received from the vCell 310 via signaling operation 320, the uplink reference signals at signaling operation 330 may be used to evaluate whether the access criteria for accessing the vCell 310 are satisfied. That is, the vCell 310 may be configured to perform measurements on the reference signals at signaling operation 330, where the measurements may be used to further evaluate whether or not the access criteria for accessing the vCell 310 are satisfied.

At signaling operation 335, the UE 115-b may receive a message (e.g., control message, measurement report) from the vCell 310. The message may indicate one or more characteristics associated with the reference signals received from the UE 115-b at signaling operation 330 via the set of serving cells of the vCell 310. For example, the message may indicate the measurements performed on the uplink reference signals, and/or an evaluation of such measurements. In some cases, the message may include cell barring information (e.g., information that indicates whether or not the UE 115-b is barred from accessing/selecting the vCell 310). For example, in cases where the measurements performed by the vCell 310 on the uplink reference signals fail to satisfy the access criteria, the vCell 310 may indicate (via the message at signaling operation 335) that the UE 115-b is barred from accessing the vCell 310.

At criteria evaluation operation 340, the UE 115-b may evaluate whether or not the access criteria for accessing the vCell 310 are satisfied or not. The UE 115-b may perform the criteria evaluation operation 340 based on receiving the control signaling at signaling operation 315, performing the measurements at measurement operation 325, receiving the message (e.g., measurements/characteristics, cell barring information) at signaling operation 335, or any combination thereof.

As noted previously herein, in some implementations, the criteria may be checked/evaluated for each of the constituent serving cells of the vCell 310 separately (e.g., separate criteria). For example, in some cases, the UE 115-b may determine that it may access the vCell 310 only if the criteria for all the respective serving cells of the vCell 310 are satisfied. In such cases, if at least one serving cell of the vCell 310 fails to satisfy the criteria, the UE 115-b may be barred from accessing/selecting the vCell 310. By way of another example, the UE 115-b may determine that it may access the vCell 310 if the criteria for at least a subset (e.g., threshold quantity or percentage) of all the respective serving cells of the vCell 310 are satisfied. In such cases, the UE 115-b may be able to access/select the vCell 310 even if the criteria for some subset of the serving cells of the vCell 310 are not satisfied.

Comparatively, in additional or alternative implementations, the criteria may be evaluated for the vCell as a whole (e.g., composite criteria). For example, the UE 115-b may be able to access the vCell 310 as long as an average RSRP/RSRQ of the serving cells of the vCell 310 satisfies some threshold.

If the access criteria for accessing the vCell 310 are not satisfied (e.g., criteria evaluation operation 340=“NO”), meaning the UE 115-b is barred from accessing the vCell 310, the process flow 300 may return to signaling operation 315, where the UE 115-b may perform the steps described herein to evaluate additional vCells 310 for cell selection/re-selection. Comparatively, if the access criteria for accessing the vCell 310 are satisfied (e.g., criteria evaluation operation 340=“YES”), meaning the UE 115-b is able to access the vCell 310, the process flow 300 may proceed to cell attachment operation 345.

At cell attachment operation 345, the UE 115-b and the vCell 310 may perform a cell attachment procedure in order to allow the UE 115-b and the vCell 310 to communicate with one another. For example, as part of the cell attachment procedure, the UE 115-b and one or more serving cells of the vCell 310 may exchange signaling as part of a RACH procedure.

At signaling operation 350, the UE 115-b and the vCell 310 may communicate with one another. That is, the UE 115-b may communicate with the network via the one or more serving cells of the vCell 310.

In some cases, the UE 115-b may be barred from accessing a subset of serving cells of the vCell 310 even when the UE 115-b is otherwise able to access the remainder of the vCell 310. That is, some serving cells of the vCell 310 may be barred, while others are accessible. In such cases, the UE 115-b may be configured to perform the cell attachment procedure at cell attachment operation 345 (and perform signaling operation 350) with only a subset of serving cells of the vCell 310.

Moreover, as noted previously herein, the respective serving cells of the vCell 310 (and the serving cell 305) may be accessible individually and/or as part of a vCell 310. In such cases, the UE 115-b may be able to access some of the serving cells of the vCell 310 individually (e.g., separate from the vCell 310) even in cases where the UE 115-b is barred from accessing the vCell 310 itself.

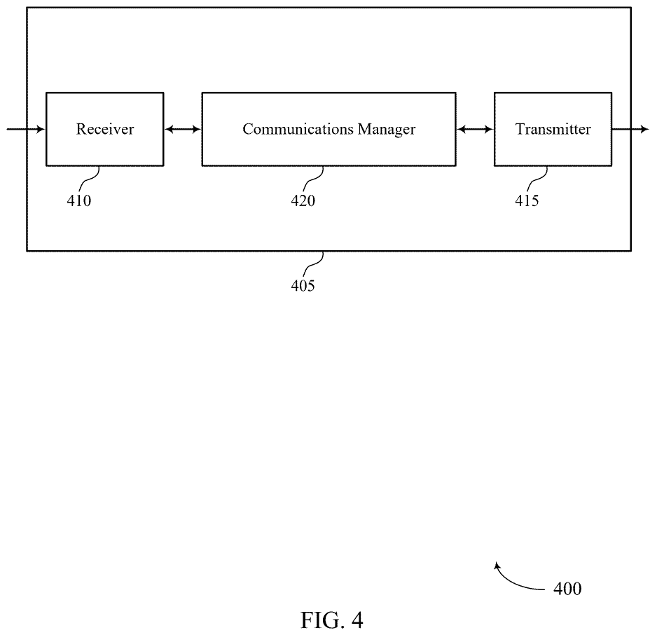

FIG. 4 shows a block diagram 400 of a device 405 that supports techniques for vCell selection for multi-carrier operation in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for vCell selection for multi-carrier operation). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for vCell selection for multi-carrier operation). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for vCell selection for multi-carrier operation as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

For example, the communications manager 420 is capable of, configured to, or operable to support a means for receiving control signaling that indicates a set of resources for receiving reference signals from a vCell, where the vCell includes a set of serving cells that are grouped together to facilitate wireless communications. The communications manager 420 is capable of, configured to, or operable to support a means for receiving one or more reference signals from the set of serving cells of the vCell via the set of resources. The communications manager 420 is capable of, configured to, or operable to support a means for performing measurements on the one or more reference signals. The communications manager 420 is capable of, configured to, or operable to support a means for performing a cell attachment procedure with the vCell to access the set of serving cells based on a set of metrics associated with the set of serving cells satisfying one or more criteria for accessing the vCell, where the set of metrics are based on the measurements.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques that enable efficient selection (and re-selection) of vCells within a wireless network. By enabling UEs 115 to efficiently identify and select vCells, aspects of the present disclosure may enable UEs 115 to attach and communicate with vCells that include with multiple serving cells, thereby increasing bandwidth and reducing latency, among other advantages.

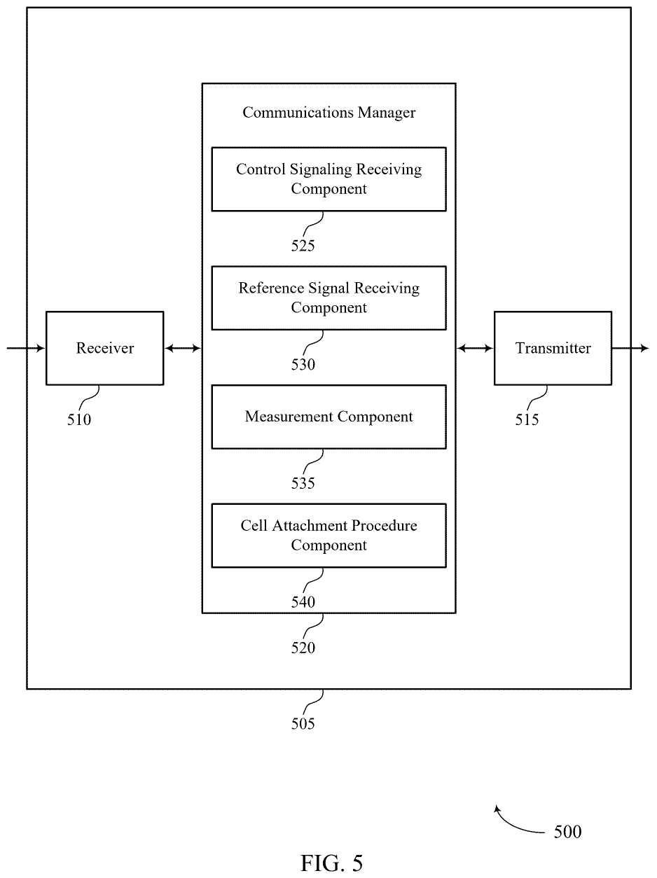

FIG. 5 shows a block diagram 500 of a device 505 that supports techniques for vCell selection for multi-carrier operation in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for vCell selection for multi-carrier operation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for vCell selection for multi-carrier operation). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for vCell selection for multi-carrier operation as described herein. For example, the communications manager 520 may include a control signaling receiving component 525, a reference signal receiving component 530, a measurement component 535, a cell attachment procedure component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The control signaling receiving component 525 is capable of, configured to, or operable to support a means for receiving control signaling that indicates a set of resources for receiving reference signals from a vCell, where the vCell includes a set of serving cells that are grouped together to facilitate wireless communications. The reference signal receiving component 530 is capable of, configured to, or operable to support a means for receiving one or more reference signals from the set of serving cells of the vCell via the set of resources. The measurement component 535 is capable of, configured to, or operable to support a means for performing measurements on the one or more reference signals. The cell attachment procedure component 540 is capable of, configured to, or operable to support a means for performing a cell attachment procedure with the vCell to access the set of serving cells based on a set of metrics associated with the set of serving cells satisfying one or more criteria for accessing the vCell, where the set of metrics are based on the measurements.

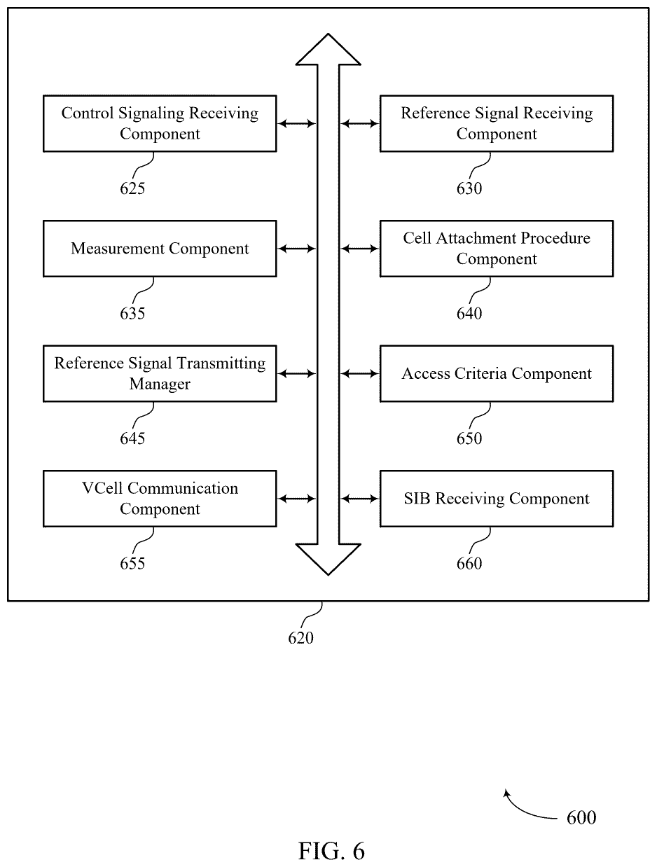

FIG. 6 shows a block diagram 600 of a communications manager 620 that supports techniques for vCell selection for multi-carrier operation in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for vCell selection for multi-carrier operation as described herein. For example, the communications manager 620 may include a control signaling receiving component 625, a reference signal receiving component 630, a measurement component 635, a cell attachment procedure component 640, a reference signal transmitting manager 645, an access criteria component 650, a vCell communication component 655, an SIB receiving component 660, or any combination thereof. Each of these components, or components or subcomponents thereof (e.g., one or more processors, one or more memories), may communicate, directly or indirectly, with one another (e.g., via one or more buses).

The control signaling receiving component 625 is capable of, configured to, or operable to support a means for receiving control signaling that indicates a set of resources for receiving reference signals from a vCell, where the vCell includes a set of serving cells that are grouped together to facilitate wireless communications. The reference signal receiving component 630 is capable of, configured to, or operable to support a means for receiving one or more reference signals from the set of serving cells of the vCell via the set of resources. The measurement component 635 is capable of, configured to, or operable to support a means for performing measurements on the one or more reference signals. The cell attachment procedure component 640 is capable of, configured to, or operable to support a means for performing a cell attachment procedure with the vCell to access the set of serving cells based on a set of metrics associated with the set of serving cells satisfying one or more criteria for accessing the vCell, where the set of metrics are based on the measurements.

In some examples, the set of serving cells of the vCell include at least a first serving cell and a second serving cell. In some examples, the set of metrics include at least a first metric and a second metric associated with the first serving cell and the second serving cell, respectively. In some examples, the set of metrics satisfy the one or more criteria based on the first metric satisfying a first criteria associated with the first serving cell, and the second metric satisfying a second criteria associated with the second serving cell.

In some examples, the reference signal transmitting manager 645 is capable of, configured to, or operable to support a means for transmitting one or more signals to the vCell. In some examples, the control signaling receiving component 625 is capable of, configured to, or operable to support a means for receiving a message from the vCell indicating one or more characteristics associated with the one or more signals received via the set of serving cells of the vCell, and where the set of metrics are based on the one or more characteristics.

In some examples, the access criteria component 650 is capable of, configured to, or operable to support a means for receiving an indication of the one or more criteria for accessing the vCell, where performing the measurements, performing the cell attachment procedure, or both, are based on receiving the indication of the one or more criteria.

In some examples, to support receiving the indication of the one or more criteria, the access criteria component 650 is capable of, configured to, or operable to support a means for receiving an indication of a first criteria associated with the first serving cell based on the first serving cell being associated with a first frequency range. In some examples, to support receiving the indication of the one or more criteria, the access criteria component 650 is capable of, configured to, or operable to support a means for receiving an indication of a second criteria associated with the second serving cell based on the second serving cell being associated with a second frequency range.

In some examples, the SIB receiving component 660 is capable of, configured to, or operable to support a means for receiving a SIB including the indication of the one or more criteria for accessing the vCell.

In some examples, the set of serving cells of the vCell include a set of multiple serving cells. In some examples, the set of metrics include a set of multiple metrics corresponding to the set of multiple serving cells. In some examples, the set of metrics satisfy the one or more criteria based on each of the set of multiple metrics satisfying the one or more criteria.

In some examples, the set of serving cells of the vCell include a set of multiple serving cells. In some examples, the set of metrics include a set of multiple metrics corresponding to the set of multiple serving cells. In some examples, the set of metrics satisfy the one or more criteria based on a threshold quantity of the set of multiple metrics satisfying the one or more criteria.

In some examples, the control signaling receiving component 625 is capable of, configured to, or operable to support a means for receiving an indication of the threshold quantity, where performing the cell attachment procedure is based on receiving the indication of the threshold quantity.

In some examples, the control signaling receiving component 625 is capable of, configured to, or operable to support a means for receiving an indication of one or more serving cells of the set of serving cells that are required to satisfy the one or more criteria for attaching to the vCell, where the set of metrics include one or more metrics associated with the one or more serving cells, where the set of metrics satisfy the one or more criteria based on one or more metrics satisfying the one or more criteria.

In some examples, the UE is barred from attaching to the vCell based on the set of metrics failing to satisfy the one or more criteria.

In some examples, the UE is further barred from attaching to any of the set of serving cells of the vCell based on the set of metrics failing to satisfy the one or more criteria.

In some examples, the set of serving cells of the vCell are individually accessible by the UE despite the UE being barred from attaching to the vCell.

In some examples, the control signaling receiving component 625 is capable of, configured to, or operable to support a means for receiving, from the vCell, additional control signaling indicating that the UE is barred from accessing the vCell based on the set of metrics failing to satisfy the one or more criteria.

In some examples, communicating with the first subset of serving cells of the vCell based on performing the cell attachment procedure and based on the first subset of metrics satisfying the one or more criteria. In some examples, refraining from communicating with the second subset of serving cells of the vCell based on the second subset of metrics failing to satisfy the one or more criteria.

In some examples, the vCell is configured to perform communications associated with a service. In some examples, the set of serving cells of the vCell are associated with the service, a different service, or both.

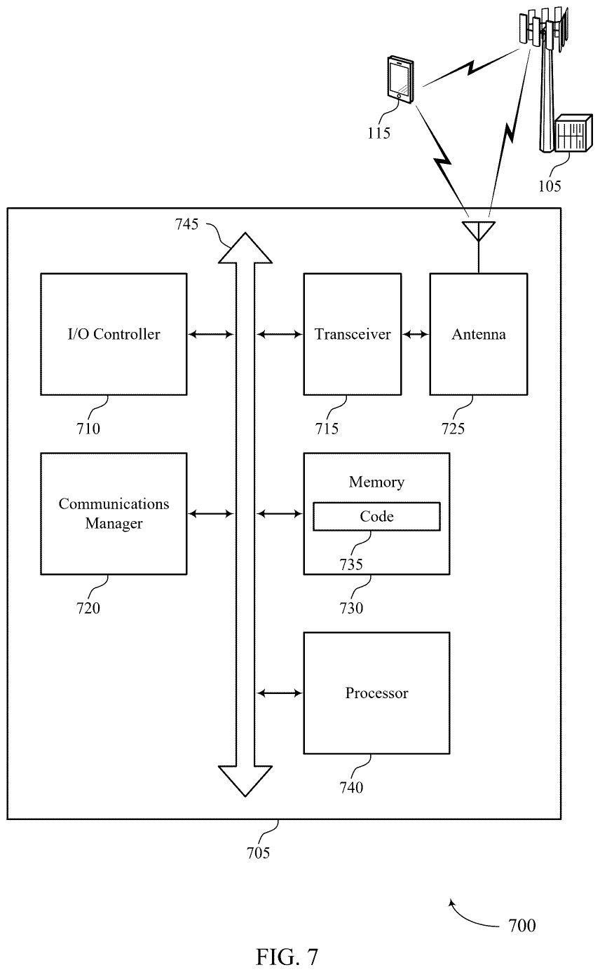

FIG. 7 shows a diagram of a system 700 including a device 705 that supports techniques for vCell selection for multi-carrier operation in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for vCell selection for multi-carrier operation). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

For example, the communications manager 720 is capable of, configured to, or operable to support a means for receiving control signaling that indicates a set of resources for receiving reference signals from a vCell, where the vCell includes a set of serving cells that are grouped together to facilitate wireless communications. The communications manager 720 is capable of, configured to, or operable to support a means for receiving one or more reference signals from the set of serving cells of the vCell via the set of resources. The communications manager 720 is capable of, configured to, or operable to support a means for performing measurements on the one or more reference signals. The communications manager 720 is capable of, configured to, or operable to support a means for performing a cell attachment procedure with the vCell to access the set of serving cells based on a set of metrics associated with the set of serving cells satisfying one or more criteria for accessing the vCell, where the set of metrics are based on the measurements.

By including or configuring the communications manager 720 in accordance with examples as described herein, the device 705 may support techniques that enable efficient selection (and re-selection) of vCells within a wireless network. By enabling UEs 115 to efficiently identify and select vCells, aspects of the present disclosure may enable UEs 115 to attach and communicate with vCells that include with multiple serving cells, thereby increasing bandwidth and reducing latency, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for vCell selection for multi-carrier operation as described herein, or the at least one processor 740 and the at least one memory 730 may be otherwise configured to, individually or collectively, perform or support such operations.

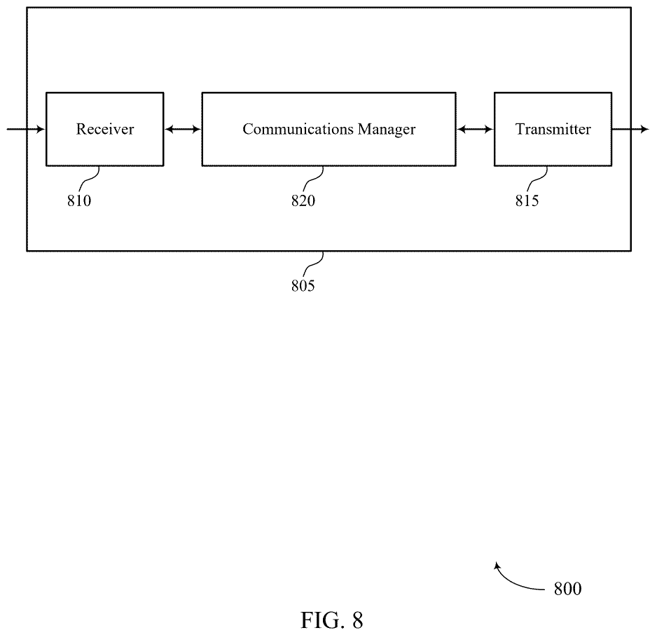

FIG. 8 shows a block diagram 800 of a device 805 that supports techniques for vCell selection for multi-carrier operation in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for vCell selection for multi-carrier operation as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 is capable of, configured to, or operable to support a means for outputting control signaling that indicates a set of resources for transmitting reference signals via a vCell supported by the network entity, where the vCell includes a set of serving cells that are grouped together to facilitate wireless communications. The communications manager 820 is capable of, configured to, or operable to support a means for outputting one or more reference signals via the set of serving cells of the vCell via the set of resources. The communications manager 820 is capable of, configured to, or operable to support a means for performing a cell attachment procedure for a UE to enable the UE to access the set of serving cells of the vCell based on a set of metrics associated with the set of serving cells satisfying one or more criteria for accessing the vCell, where the set of metrics are based on the reference signals.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques that enable efficient selection (and re-selection) of vCells within a wireless network. By enabling UEs 115 to efficiently identify and select vCells, aspects of the present disclosure may enable UEs 115 to attach and communicate with vCells that include with multiple serving cells, thereby increasing bandwidth and reducing latency, among other advantages.

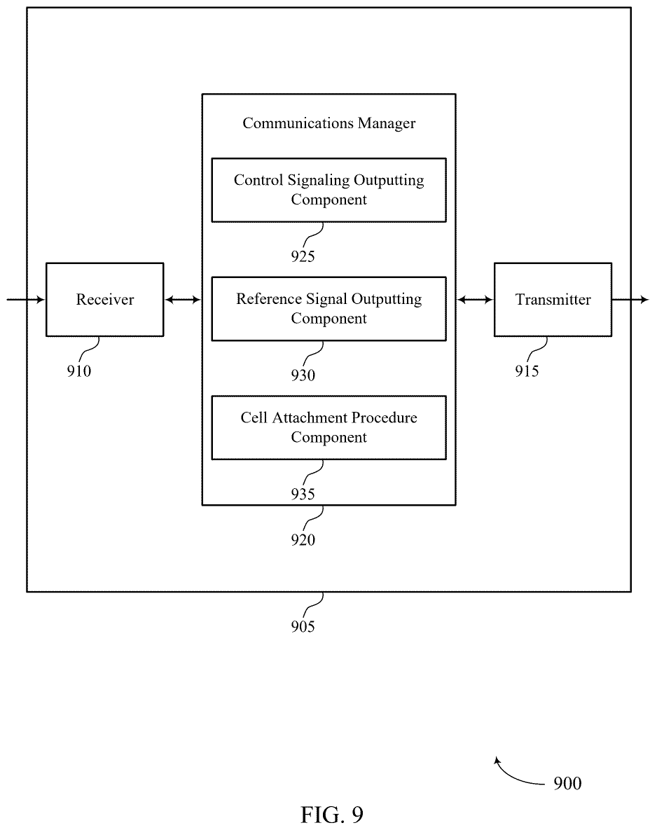

FIG. 9 shows a block diagram 900 of a device 905 that supports techniques for vCell selection for multi-carrier operation in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for vCell selection for multi-carrier operation as described herein. For example, the communications manager 920 may include a control signaling outputting component 925, a reference signal outputting component 930, a cell attachment procedure component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The control signaling outputting component 925 is capable of, configured to, or operable to support a means for outputting control signaling that indicates a set of resources for transmitting reference signals via a vCell supported by the network entity, where the vCell includes a set of serving cells that are grouped together to facilitate wireless communications. The reference signal outputting component 930 is capable of, configured to, or operable to support a means for outputting one or more reference signals via the set of serving cells of the vCell via the set of resources. The cell attachment procedure component 935 is capable of, configured to, or operable to support a means for performing a cell attachment procedure for a UE to enable the UE to access the set of serving cells of the vCell based on a set of metrics associated with the set of serving cells satisfying one or more criteria for accessing the vCell, where the set of metrics are based on the reference signals.

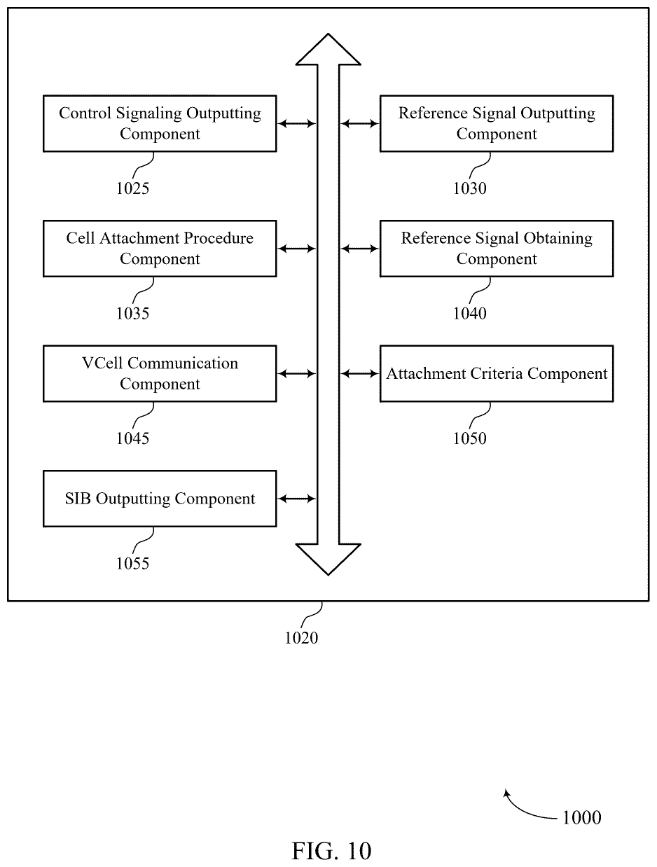

FIG. 10 shows a block diagram 1000 of a communications manager 1020 that supports techniques for vCell selection for multi-carrier operation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for vCell selection for multi-carrier operation as described herein. For example, the communications manager 1020 may include a control signaling outputting component 1025, a reference signal outputting component 1030, a cell attachment procedure component 1035, a reference signal obtaining component 1040, a vCell communication component 1045, an attachment criteria component 1050, an SIB outputting component 1055, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The control signaling outputting component 1025 is capable of, configured to, or operable to support a means for outputting control signaling that indicates a set of resources for transmitting reference signals via a vCell supported by the network entity, where the vCell includes a set of serving cells that are grouped together to facilitate wireless communications. The reference signal outputting component 1030 is capable of, configured to, or operable to support a means for outputting one or more reference signals via the set of serving cells of the vCell via the set of resources. The cell attachment procedure component 1035 is capable of, configured to, or operable to support a means for performing a cell attachment procedure for a UE to enable the UE to access the set of serving cells of the vCell based on a set of metrics associated with the set of serving cells satisfying one or more criteria for accessing the vCell, where the set of metrics are based on the reference signals.

In some examples, the set of serving cells of the vCell include at least a first serving cell and a second serving cell. In some examples, the set of metrics include at least a first metric and a second metric associated with the first serving cell and the second serving cell, respectively. In some examples, the set of metrics satisfy the one or more criteria based on the first metric satisfying a first criteria associated with the first serving cell, and the second metric satisfying a second criteria associated with the second serving cell.

In some examples, the reference signal obtaining component 1040 is capable of, configured to, or operable to support a means for obtaining one or more signals from the UE. In some examples, the control signaling outputting component 1025 is capable of, configured to, or operable to support a means for outputting a message to the UE via the vCell, the message indicating one or more characteristics associated with the one or more signals received via the set of serving cells of the vCell, and where the set of metrics are based on the one or more characteristics.

In some examples, the control signaling outputting component 1025 is capable of, configured to, or operable to support a means for outputting an indication of the one or more criteria for accessing the vCell, where performing the cell attachment procedure is based on outputting the indication of the one or more criteria.

In some examples, to support outputting the indication of the one or more criteria, the attachment criteria component 1050 is capable of, configured to, or operable to support a means for outputting an indication of a first criteria associated with the first serving cell based on the first serving cell being associated with a first frequency range. In some examples, to support outputting the indication of the one or more criteria, the attachment criteria component 1050 is capable of, configured to, or operable to support a means for outputting an indication of a second criteria associated with the second serving cell based on the second serving cell being associated with a second frequency range.

In some examples, the SIB outputting component 1055 is capable of, configured to, or operable to support a means for outputting a SIB including the indication of the one or more criteria for accessing the vCell.

In some examples, the set of serving cells of the vCell include a set of multiple serving cells. In some examples, the set of metrics include a set of multiple metrics corresponding to the set of multiple serving cells. In some examples, the set of metrics satisfy the one or more criteria based on each of the set of multiple metrics satisfying the one or more criteria.

In some examples, the set of serving cells of the vCell include a set of multiple serving cells. In some examples, the set of metrics include a set of multiple metrics corresponding to the set of multiple serving cells. In some examples, the set of metrics satisfy the one or more criteria based on a threshold quantity of the set of multiple metrics satisfying the one or more criteria.

In some examples, the control signaling outputting component 1025 is capable of, configured to, or operable to support a means for outputting an indication of the threshold quantity, where performing the cell attachment procedure is based on outputting the indication of the threshold quantity.

In some examples, the control signaling outputting component 1025 is capable of, configured to, or operable to support a means for outputting an indication of one or more serving cells of the set of serving cells that are required to satisfy the one or more criteria for attaching to the vCell, where the set of metrics include one or more metrics associated with the one or more serving cells, where the set of metrics satisfy the one or more criteria based on one or more metrics satisfying the one or more criteria.

In some examples, the UE is barred from attaching to the vCell based on the set of metrics failing to satisfy the one or more criteria.

In some examples, the UE is further barred from attaching to any of the set of serving cells of the vCell based on the set of metrics failing to satisfy the one or more criteria.

In some examples, the set of serving cells of the vCell are individually accessible by the UE despite the UE being barred from attaching to the vCell.

In some examples, the control signaling outputting component 1025 is capable of, configured to, or operable to support a means for outputting, to the UE via the vCell, additional control signaling indicating that the UE is barred from accessing the vCell based on the set of metrics failing to satisfy the one or more criteria.

In some examples, communicating with the UE via the first subset of serving cells of the vCell based on performing the cell attachment procedure and based on the first subset of metrics satisfying the one or more criteria. In some examples, refraining from communicating with the UE via the second subset of serving cells of the vCell based on the second subset of metrics failing to satisfy the one or more criteria.

In some examples, the vCell is configured to perform communications associated with a service. In some examples, the set of serving cells of the vCell are associated with the service, a different service, or both.

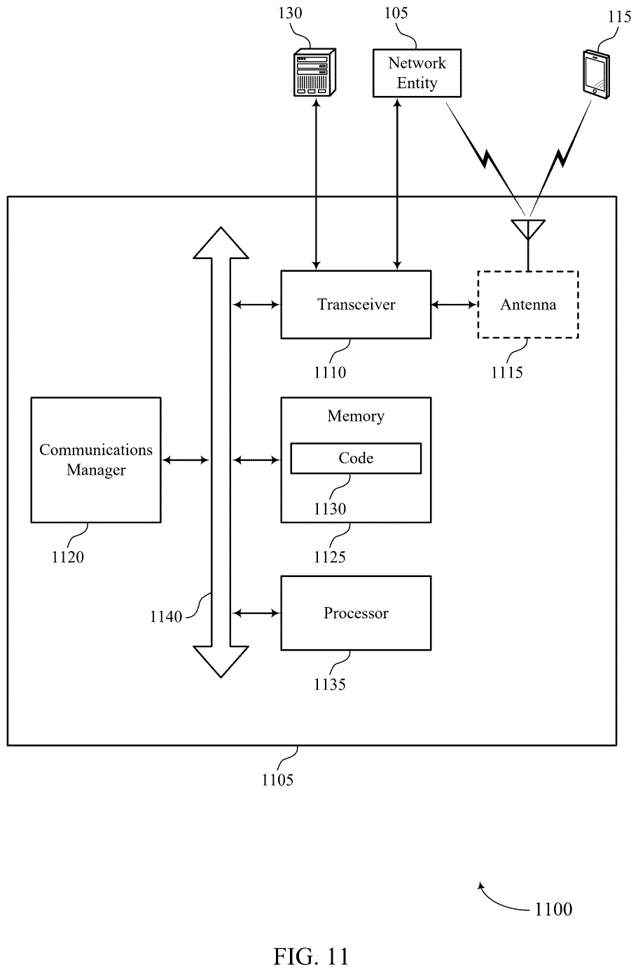

FIG. 11 shows a diagram of a system 1100 including a device 1105 that supports techniques for vCell selection for multi-carrier operation in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for vCell selection for multi-carrier operation). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

For example, the communications manager 1120 is capable of, configured to, or operable to support a means for outputting control signaling that indicates a set of resources for transmitting reference signals via a vCell supported by the network entity, where the vCell includes a set of serving cells that are grouped together to facilitate wireless communications. The communications manager 1120 is capable of, configured to, or operable to support a means for outputting one or more reference signals via the set of serving cells of the vCell via the set of resources. The communications manager 1120 is capable of, configured to, or operable to support a means for performing a cell attachment procedure for a UE to enable the UE to access the set of serving cells of the vCell based on a set of metrics associated with the set of serving cells satisfying one or more criteria for accessing the vCell, where the set of metrics are based on the reference signals.

By including or configuring the communications manager 1120 in accordance with examples as described herein, the device 1105 may support techniques that enable efficient selection (and re-selection) of vCells within a wireless network. By enabling UEs 115 to efficiently identify and select vCells, aspects of the present disclosure may enable UEs 115 to attach and communicate with vCells that include with multiple serving cells, thereby increasing bandwidth and reducing latency, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for vCell selection for multi-carrier operation as described herein, or the at least one processor 1135 and the at least one memory 1125 may be otherwise configured to, individually or collectively, perform or support such operations.

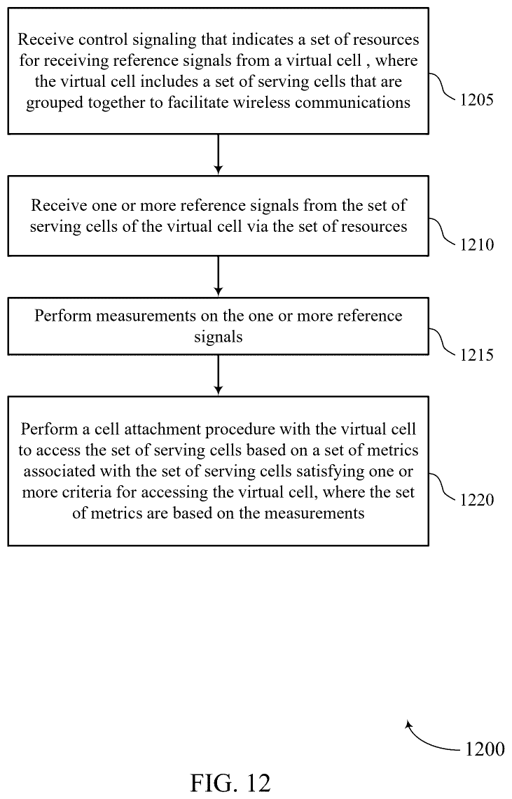

FIG. 12 shows a flowchart illustrating a method 1200 that supports techniques for vCell selection for multi-carrier operation in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving control signaling that indicates a set of resources for receiving reference signals from a vCell, where the vCell includes a set of serving cells that are grouped together to facilitate wireless communications. The operations of 1205 may be performed in accordance with examples as disclosed herein. In some examples, aspects of the operations of 1205 may be performed by a control signaling receiving component 625 as described with reference to FIG. 6.

At 1210, the method may include receiving one or more reference signals from the set of serving cells of the vCell via the set of resources. The operations of 1210 may be performed in accordance with examples as disclosed herein. In some examples, aspects of the operations of 1210 may be performed by a reference signal receiving component 630 as described with reference to FIG. 6.

At 1215, the method may include performing measurements on the one or more reference signals. The operations of 1215 may be performed in accordance with examples as disclosed herein. In some examples, aspects of the operations of 1215 may be performed by a measurement component 635 as described with reference to FIG. 6.

At 1220, the method may include performing a cell attachment procedure with the vCell to access the set of serving cells based on a set of metrics associated with the set of serving cells satisfying one or more criteria for accessing the vCell, where the set of metrics are based on the measurements. The operations of 1220 may be performed in accordance with examples as disclosed herein. In some examples, aspects of the operations of 1220 may be performed by a cell attachment procedure component 640 as described with reference to FIG. 6.

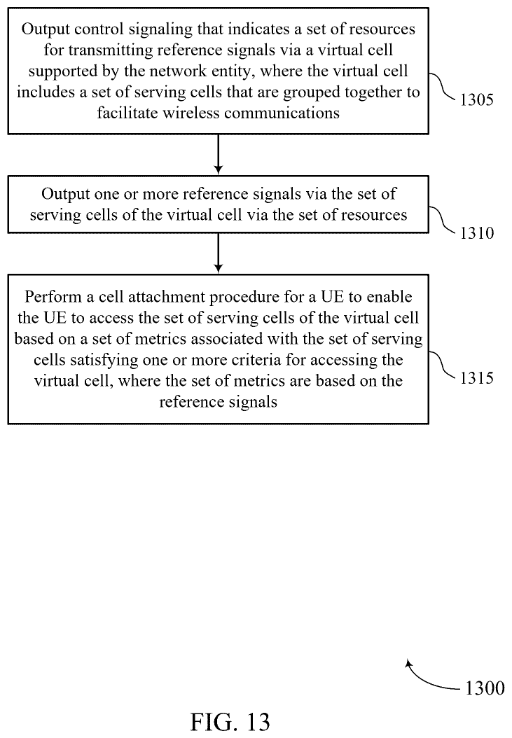

FIG. 13 shows a flowchart illustrating a method 1300 that supports techniques for vCell selection for multi-carrier operation in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include outputting control signaling that indicates a set of resources for transmitting reference signals via a vCell supported by the network entity, where the vCell includes a set of serving cells that are grouped together to facilitate wireless communications. The operations of 1305 may be performed in accordance with examples as disclosed herein. In some examples, aspects of the operations of 1305 may be performed by a control signaling outputting component 1025 as described with reference to FIG. 10.

At 1310, the method may include outputting one or more reference signals via the set of serving cells of the vCell via the set of resources. The operations of 1310 may be performed in accordance with examples as disclosed herein. In some examples, aspects of the operations of 1310 may be performed by a reference signal outputting component 1030 as described with reference to FIG. 10.

At 1315, the method may include performing a cell attachment procedure for a UE to enable the UE to access the set of serving cells of the vCell based on a set of metrics associated with the set of serving cells satisfying one or more criteria for accessing the vCell, where the set of metrics are based on the reference signals. The operations of 1315 may be performed in accordance with examples as disclosed herein. In some examples, aspects of the operations of 1315 may be performed by a cell attachment procedure component 1035 as described with reference to FIG. 10.

The following provides an overview of aspects of the present disclosure:

Aspect 1: A method for wireless communications at a UE, comprising: receiving control signaling that indicates a set of resources for receiving reference signals from a vCell, wherein the vCell comprises a set of serving cells that are grouped together to facilitate wireless communications; receiving one or more reference signals from the set of serving cells of the vCell via the set of resources; performing measurements on the one or more reference signals; and performing a cell attachment procedure with the vCell to access the set of serving cells based at least in part on a set of metrics associated with the set of serving cells satisfying one or more criteria for accessing the vCell, wherein the set of metrics are based at least in part on the measurements.

Aspect 2: The method of aspect 1, wherein the set of serving cells of the vCell comprise at least a first serving cell and a second serving cell, the set of metrics comprise at least a first metric and a second metric associated with the first serving cell and the second serving cell, respectively, the set of metrics satisfy the one or more criteria based at least in part on the first metric satisfying a first criteria associated with the first serving cell, and the second metric satisfying a second criteria associated with the second serving cell.

Aspect 3: The method of any of aspects 1 through 2, further comprising: transmitting one or more signals to the vCell; and receiving a message from the vCell indicating one or more characteristics associated with the one or more signals received via the set of serving cells of the vCell, and wherein the set of metrics are based at least in part on the one or more characteristics.

Aspect 4: The method of any of aspects 1 through 3, further comprising: receiving an indication of the one or more criteria for accessing the vCell, wherein performing the measurements, performing the cell attachment procedure, or both, are based at least in part on receiving the indication of the one or more criteria.

Aspect 5: The method of aspect 4, wherein the set of serving cells comprise at least a first serving cell and a second serving cell, and wherein receiving the indication of the one or more criteria comprises: receiving an indication of a first criteria associated with the first serving cell based at least in part on the first serving cell being associated with a first frequency range; and receiving an indication of a second criteria associated with the second serving cell based at least in part on the second serving cell being associated with a second frequency range.

Aspect 6: The method of any of aspects 4 through 5, further comprising: receiving a system information block comprising the indication of the one or more criteria for accessing the vCell.

Aspect 7: The method of any of aspects 1 through 6, wherein the set of serving cells of the vCell comprise a plurality of serving cells, the set of metrics comprise a plurality of metrics corresponding to the plurality of serving cells, the set of metrics satisfy the one or more criteria based at least in part on each of the plurality of metrics satisfying the one or more criteria.

Aspect 8: The method of any of aspects 1 through 7, wherein the set of serving cells of the vCell comprise a plurality of serving cells, the set of metrics comprise a plurality of metrics corresponding to the plurality of serving cells, the set of metrics satisfy the one or more criteria based at least in part on a threshold quantity of the plurality of metrics satisfying the one or more criteria.

Aspect 9: The method of aspect 8, further comprising: receiving an indication of the threshold quantity, wherein performing the cell attachment procedure is based at least in part on receiving the indication of the threshold quantity.

Aspect 10: The method of any of aspects 1 through 9, further comprising: receiving an indication of one or more serving cells of the set of serving cells that are required to satisfy the one or more criteria for attaching to the vCell, wherein the set of metrics comprise one or more metrics associated with the one or more serving cells, wherein the set of metrics satisfy the one or more criteria based at least in part on one or more metrics satisfying the one or more criteria.

Aspect 11: The method of any of aspects 1 through 10, wherein the UE is barred from attaching to the vCell based at least in part on the set of metrics failing to satisfy the one or more criteria.

Aspect 12: The method of aspect 11, wherein the UE is further barred from attaching to any of the set of serving cells of the vCell based at least in part on the set of metrics failing to satisfy the one or more criteria.

Aspect 13: The method of any of aspects 11 through 12, wherein the set of serving cells of the vCell are individually accessible by the UE despite the UE being barred from attaching to the vCell.

Aspect 14: The method of any of aspects 11 through 13, further comprising: receiving, from the vCell, additional control signaling indicating that the UE is barred from accessing the vCell based at least in part on the set of metrics failing to satisfy the one or more criteria.

Aspect 15: The method of any of aspects 1 through 14, wherein the set of metrics comprise a first subset of metrics associated with a first subset of serving cells of the vCell, and a second subset of metrics associated with a second subset of serving cells of the vCell, the method comprising communicating with the first subset of serving cells of the vCell based at least in part on performing the cell attachment procedure and based at least in part on the first subset of metrics satisfying the one or more criteria; and refraining from communicating with the second subset of serving cells of the vCell based at least in part on the second subset of metrics failing to satisfy the one or more criteria.

Aspect 16: The method of any of aspects 1 through 15, wherein the vCell is configured to perform communications associated with a service, the set of serving cells of the vCell are associated with the service, a different service, or both.

Aspect 17: A method for wireless communications at a network entity, comprising: outputting control signaling that indicates a set of resources for transmitting reference signals via a vCell supported by the network entity, wherein the vCell comprises a set of serving cells that are grouped together to facilitate wireless communications; outputting one or more reference signals via the set of serving cells of the vCell via the set of resources; and performing a cell attachment procedure for a UE to enable the UE to access the set of serving cells of the vCell based at least in part on a set of metrics associated with the set of serving cells satisfying one or more criteria for accessing the vCell, wherein the set of metrics are based at least in part on the reference signals.

Aspect 18: The method of aspect 17, wherein the set of serving cells of the vCell comprise at least a first serving cell and a second serving cell, the set of metrics comprise at least a first metric and a second metric associated with the first serving cell and the second serving cell, respectively, the set of metrics satisfy the one or more criteria based at least in part on the first metric satisfying a first criteria associated with the first serving cell, and the second metric satisfying a second criteria associated with the second serving cell.

Aspect 19: The method of any of aspects 17 through 18, further comprising: obtaining one or more signals from the UE; and outputting a message to the UE via the vCell, the message indicating one or more characteristics associated with the one or more signals received via the set of serving cells of the vCell, and wherein the set of metrics are based at least in part on the one or more characteristics.

Aspect 20: The method of any of aspects 17 through 19, further comprising: outputting an indication of the one or more criteria for accessing the vCell, wherein performing the cell attachment procedure is based at least in part on outputting the indication of the one or more criteria.

Aspect 21: The method of aspect 20, wherein the set of serving cells comprise at least a first serving cell and a second serving cell, and wherein outputting the indication of the one or more criteria comprises: outputting an indication of a first criteria associated with the first serving cell based at least in part on the first serving cell being associated with a first frequency range; and outputting an indication of a second criteria associated with the second serving cell based at least in part on the second serving cell being associated with a second frequency range.

Aspect 22: The method of any of aspects 20 through 21, further comprising: outputting a system information block comprising the indication of the one or more criteria for accessing the vCell.

Aspect 23: The method of any of aspects 17 through 22, wherein the set of serving cells of the vCell comprise a plurality of serving cells, the set of metrics comprise a plurality of metrics corresponding to the plurality of serving cells, the set of metrics satisfy the one or more criteria based at least in part on each of the plurality of metrics satisfying the one or more criteria.

Aspect 24: The method of any of aspects 17 through 23, wherein the set of serving cells of the vCell comprise a plurality of serving cells, the set of metrics comprise a plurality of metrics corresponding to the plurality of serving cells, the set of metrics satisfy the one or more criteria based at least in part on a threshold quantity of the plurality of metrics satisfying the one or more criteria.

Aspect 25: The method of aspect 24, further comprising: outputting an indication of the threshold quantity, wherein performing the cell attachment procedure is based at least in part on outputting the indication of the threshold quantity.

Aspect 26: The method of any of aspects 17 through 25, further comprising: outputting an indication of one or more serving cells of the set of serving cells that are required to satisfy the one or more criteria for attaching to the vCell, wherein the set of metrics comprise one or more metrics associated with the one or more serving cells, wherein the set of metrics satisfy the one or more criteria based at least in part on one or more metrics satisfying the one or more criteria.

Aspect 27: The method of any of aspects 17 through 26, wherein the UE is barred from attaching to the vCell based at least in part on the set of metrics failing to satisfy the one or more criteria.

Aspect 28: The method of aspect 27, wherein the UE is further barred from attaching to any of the set of serving cells of the vCell based at least in part on the set of metrics failing to satisfy the one or more criteria.

Aspect 29: The method of any of aspects 27 through 28, wherein the set of serving cells of the vCell are individually accessible by the UE despite the UE being barred from attaching to the vCell.

Aspect 30: The method of any of aspects 27 through 29, further comprising: outputting, to the UE via the vCell, additional control signaling indicating that the UE is barred from accessing the vCell based at least in part on the set of metrics failing to satisfy the one or more criteria.

Aspect 31: The method of any of aspects 17 through 30, wherein the set of metrics comprise a first subset of metrics associated with a first subset of serving cells of the vCell, and a second subset of metrics associated with a second subset of serving cells of the vCell, the method comprising communicating with the UE via the first subset of serving cells of the vCell based at least in part on performing the cell attachment procedure and based at least in part on the first subset of metrics satisfying the one or more criteria; and refraining from communicating with the UE via the second subset of serving cells of the vCell based at least in part on the second subset of metrics failing to satisfy the one or more criteria.

Aspect 32: The method of any of aspects 17 through 31, wherein the vCell is configured to perform communications associated with a service, the set of serving cells of the vCell are associated with the service, a different service, or both.

Aspect 33: A UE comprising one or more memories storing processor-executable code, and one or more processors coupled with the one or more memories and individually or collectively operable to execute the code to cause the UE to perform a method of any of aspects 1 through 16.

Aspect 34: A UE comprising at least one means for performing a method of any of aspects 1 through 16.

Aspect 35: A non-transitory computer-readable medium storing code the code comprising instructions executable by one or more processors to perform a method of any of aspects 1 through 16.

Aspect 36: A network entity comprising one or more memories storing processor-executable code, and one or more processors coupled with the one or more memories and individually or collectively operable to execute the code to cause the network entity to perform a method of any of aspects 17 through 32.

Aspect 37: A network entity comprising at least one means for performing a method of any of aspects 17 through 32.

Aspect 38: A non-transitory computer-readable medium storing code the code comprising instructions executable by one or more processors to perform a method of any of aspects 17 through 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that indicates a set of resources for receiving reference signals from a virtual cell, wherein the virtual cell comprises a set of serving cells that are grouped together to facilitate wireless communications;
receive one or more reference signals from the set of serving cells of the virtual cell via the set of resources;
perform measurements on the one or more reference signals; and
perform a cell attachment procedure with the virtual cell to access the set of serving cells based at least in part on a set of metrics associated with the set of serving cells satisfying one or more criteria for accessing the virtual cell, wherein the set of metrics are based at least in part on the measurements.

2. The UE of claim 1, wherein the set of serving cells of the virtual cell comprise at least a first serving cell and a second serving cell, wherein the set of metrics comprise at least a first metric and a second metric associated with the first serving cell and the second serving cell, respectively, wherein the set of metrics satisfy the one or more criteria based at least in part on the first metric satisfying a first criteria associated with the first serving cell, and the second metric satisfying a second criteria associated with the second serving cell.

3. The UE of claim 1, wherein the one or more processors are individually or collectively further operable to execute the code to cause the UE to:
transmit one or more signals to the virtual cell; and
receive a message from the virtual cell indicating one or more characteristics associated with the one or more signals received via the set of serving cells of the virtual cell, and wherein the set of metrics are based at least in part on the one or more characteristics.

4. The UE of claim 1, wherein the one or more processors are individually or collectively further operable to execute the code to cause the UE to:
receive an indication of the one or more criteria for accessing the virtual cell, wherein performing the measurements, performing the cell attachment procedure, or both, are based at least in part on receiving the indication of the one or more criteria.

5. The UE of claim 4, wherein the set of serving cells comprise at least a first serving cell and a second serving cell, and wherein, to receive the indication of the one or more criteria, the one or more processors are individually or collectively operable to execute the code to cause the UE to:
receive an indication of a first criteria associated with the first serving cell based at least in part on the first serving cell being associated with a first frequency range; and
receive an indication of a second criteria associated with the second serving cell based at least in part on the second serving cell being associated with a second frequency range.

6. The UE of claim 4, wherein the one or more processors are individually or collectively further operable to execute the code to cause the UE to:
receive a system information block comprising the indication of the one or more criteria for accessing the virtual cell.

7. The UE of claim 1, wherein the set of serving cells of the virtual cell comprise a plurality of serving cells, wherein the set of metrics comprise a plurality of metrics corresponding to the plurality of serving cells, wherein the set of metrics satisfy the one or more criteria based at least in part on each of the plurality of metrics satisfying the one or more criteria.

8. The UE of claim 1, wherein the set of serving cells of the virtual cell comprise a plurality of serving cells, wherein the set of metrics comprise a plurality of metrics corresponding to the plurality of serving cells, wherein the set of metrics satisfy the one or more criteria based at least in part on a threshold quantity of the plurality of metrics satisfying the one or more criteria.

9. The UE of claim 8, wherein the one or more processors are individually or collectively further operable to execute the code to cause the UE to:
receive an indication of the threshold quantity, wherein performing the cell attachment procedure is based at least in part on receiving the indication of the threshold quantity.

10. The UE of claim 1, wherein the one or more processors are individually or collectively further operable to execute the code to cause the UE to:
receive an indication of one or more serving cells of the set of serving cells that are required to satisfy the one or more criteria for attaching to the virtual cell, wherein the set of metrics comprise one or more metrics associated with the one or more serving cells, wherein the set of metrics satisfy the one or more criteria based at least in part on one or more metrics satisfying the one or more criteria.

11. The UE of claim 1, wherein the UE is barred from attaching to the virtual cell based at least in part on the set of metrics failing to satisfy the one or more criteria.

12. The UE of claim 11, wherein the UE is further barred from attaching to any of the set of serving cells of the virtual cell based at least in part on the set of metrics failing to satisfy the one or more criteria.

13. The UE of claim 11, wherein the set of serving cells of the virtual cell are individually accessible by the UE despite the UE being barred from attaching to the virtual cell.

14. The UE of claim 11, wherein the one or more processors are individually or collectively further operable to execute the code to cause the UE to:
receive, from the virtual cell, additional control signaling indicating that the UE is barred from accessing the virtual cell based at least in part on the set of metrics failing to satisfy the one or more criteria.

15. The UE of claim 1, wherein the set of metrics comprise a first subset of metrics associated with a first subset of serving cells of the virtual cell, and a second subset of metrics associated with a second subset of serving cells of the virtual cell, wherein the one or more processors are individually or collectively further operable to execute the code to cause the UE to:
communicate with the first subset of serving cells of the virtual cell based at least in part on performing the cell attachment procedure and based at least in part on the first subset of metrics satisfying the one or more criteria; and
refrain from communicating with the second subset of serving cells of the virtual cell based at least in part on the second subset of metrics failing to satisfy the one or more criteria.

16. The UE of claim 1, wherein the virtual cell is configured to perform communications associated with a service, wherein the set of serving cells of the virtual cell are associated with the service, a different service, or both.

17. A network entity, comprising:
one or more memories storing processor-executable code; and
one or more processors coupled with the one or more memories and individually or collectively operable to execute the code to cause the network entity to:
output control signaling that indicates a set of resources for transmitting reference signals via a virtual cell supported by the network entity, wherein the virtual cell comprises a set of serving cells that are grouped together to facilitate wireless communications;
output one or more reference signals via the set of serving cells of the virtual cell via the set of resources; and
perform a cell attachment procedure for a user equipment (UE) to enable the UE to access the set of serving cells of the virtual cell based at least in part on a set of metrics associated with the set of serving cells satisfying one or more criteria for accessing the virtual cell, wherein the set of metrics are based at least in part on the reference signals.

18. The network entity of claim 17, wherein the set of serving cells of the virtual cell comprise at least a first serving cell and a second serving cell, wherein the set of metrics comprise at least a first metric and a second metric associated with the first serving cell and the second serving cell, respectively, wherein the set of metrics satisfy the one or more criteria based at least in part on the first metric satisfying a first criteria associated with the first serving cell, and the second metric satisfying a second criteria associated with the second serving cell.

19. The network entity of claim 17, wherein the one or more processors are individually or collectively further operable to execute the code to cause the network entity to:
obtain one or more signals from the UE; and
output a message to the UE via the virtual cell, the message indicating one or more characteristics associated with the one or more signals received via the set of serving cells of the virtual cell, and wherein the set of metrics are based at least in part on the one or more characteristics.

20. The network entity of claim 17, wherein the one or more processors are individually or collectively further operable to execute the code to cause the network entity to:
output an indication of the one or more criteria for accessing the virtual cell, wherein performing the cell attachment procedure is based at least in part on outputting the indication of the one or more criteria.

21. The network entity of claim 20, wherein the set of serving cells comprise at least a first serving cell and a second serving cell, and wherein, to output the indication of the one or more criteria, the one or more processors are individually or collectively operable to execute the code to cause the network entity to:
output an indication of a first criteria associated with the first serving cell based at least in part on the first serving cell being associated with a first frequency range; and
output an indication of a second criteria associated with the second serving cell based at least in part on the second serving cell being associated with a second frequency range.

22. The network entity of claim 20, wherein the one or more processors are individually or collectively further operable to execute the code to cause the network entity to:
output a system information block comprising the indication of the one or more criteria for accessing the virtual cell.

23. The network entity of claim 17, wherein the set of serving cells of the virtual cell comprise a plurality of serving cells, wherein the set of metrics comprise a plurality of metrics corresponding to the plurality of serving cells, wherein the set of metrics satisfy the one or more criteria based at least in part on each of the plurality of metrics satisfying the one or more criteria.

24. The network entity of claim 17, wherein the set of serving cells of the virtual cell comprise a plurality of serving cells, wherein the set of metrics comprise a plurality of metrics corresponding to the plurality of serving cells, wherein the set of metrics satisfy the one or more criteria based at least in part on a threshold quantity of the plurality of metrics satisfying the one or more criteria.

25. The network entity of claim 24, wherein the one or more processors are individually or collectively further operable to execute the code to cause the network entity to:
output an indication of the threshold quantity, wherein performing the cell attachment procedure is based at least in part on outputting the indication of the threshold quantity.

26. The network entity of claim 17, wherein the one or more processors are individually or collectively further operable to execute the code to cause the network entity to:
output an indication of one or more serving cells of the set of serving cells that are required to satisfy the one or more criteria for attaching to the virtual cell, wherein the set of metrics comprise one or more metrics associated with the one or more serving cells, wherein the set of metrics satisfy the one or more criteria based at least in part on one or more metrics satisfying the one or more criteria.

27. The network entity of claim 17, wherein the UE is barred from attaching to the virtual cell based at least in part on the set of metrics failing to satisfy the one or more criteria.

28. A method for wireless communications at a user equipment (UE), comprising:
receiving control signaling that indicates a set of resources for receiving reference signals from a virtual cell, wherein the virtual cell comprises a set of serving cells that are grouped together to facilitate wireless communications;
receiving one or more reference signals from the set of serving cells of the virtual cell via the set of resources;
performing measurements on the one or more reference signals; and
performing a cell attachment procedure with the virtual cell to access the set of serving cells based at least in part on a set of metrics associated with the set of serving cells satisfying one or more criteria for accessing the virtual cell, wherein the set of metrics are based at least in part on the measurements.

29. A method for wireless communications at a network entity, comprising:
outputting control signaling that indicates a set of resources for transmitting reference signals via a virtual cell supported by the network entity, wherein the virtual cell comprises a set of serving cells that are grouped together to facilitate wireless communications;
outputting one or more reference signals via the set of serving cells of the virtual cell via the set of resources; and
performing a cell attachment procedure for a user equipment (UE) to enable the UE to access the set of serving cells of the virtual cell based at least in part on a set of metrics associated with the set of serving cells satisfying one or more criteria for accessing the virtual cell, wherein the set of metrics are based at least in part on the reference signals.
